(19) United States
(12) Patent Application Publication
(10) Pub. No.: US 2007/0122132 A1
(43) Pub. Date: May 31, 2007

(54) Camera shake compensation unit, image taking apparatus, image taking system, and method of compensating for image formation position

(75) Inventors: Takeshi Misawa, Asaka (JP); Tatsuhiko Hagiwara, Asaka (JP); Naoyuki Nishikawa, Minami-Ashigara (JP); Kazuhiko Onda, Saitama (JP)

Correspondence Address: SUGHRUE MION, PLLC, 2100 PENNSYLVANIA AVENUE, N.W., SUITE 800, WASHINGTON, DC, 20037, US

(73) Assignee: FUJIFILM Corporation

(21) Appl. No.: 11/598,748

(22) Filed: Nov. 14, 2006

(30) Foreign Application Priority Data
Nov. 18, 2005 (JP) 2005-334188
Dec. 2, 2005 (JP) 2005-349191
Dec. 2, 2005 (JP) 2005-349195

(51) Int. Cl. G03B 17/00

(52) U.S. Cl. 396/55

(57) ABSTRACT

A camera shake compensation unit includes (1) a mobile optical device which changes the direction of the light running through the mobile optical device by moving on a two-dimensional plane which intersects with the direction along the light; (2) a camera shake detection section; (3) a polymer actuator; and (4) a camera shake compensation section which compensates for displacement of the light by supplying a voltage corresponding to a detection result by the camera shake detection section to the plurality of electrodes. The polymer actuator includes (i) a polymer membrane which expands and contracts in response to application of a voltage, and connects the mobile optical device with a holding section, and (ii) a plurality of electrodes for application of a voltage to parts of the polymer membrane.

### BACKGROUND OF THE INVENTION

1. Field of the Invention

The present invention relates to a camera shake compensation unit which has a mechanism to compensate for a camera shake, an image taking apparatus which shoots an image formed by light incident from a subject, an image taking system and a method of compensating for an image formation position by compensating displacement of an image formation position.

2. Description of the Related Art

Recently, an image taking apparatus such as a digital camera has been popular and many people enjoy taking a photo.

When they takes a photo by using the image taking apparatus, pressing a shutter button may cause a camera shake. Also, in a manufacturing process of an image taking apparatus, so-called eccentricity of an optical device may occur by mounting an optical device and an image taking device in a displaced position relative to each other. Such a camera shake and an eccentricity of an optical device bring about displacement of an image formation position, resulting in displacement of an image formed by shooting.

In order to compensate for a camera shake, some image taking apparatuses have a mechanism to compensate for the effect of shakes of these image taking apparatuses at the moment when a shutter button is pressed, by changing a position of an optical device or an image taking device along an optical axis (e.g., Japanese Patent Laid-Open No. S50-80854 and Japanese Patent Laid-Open No. S62-47013). On the other hand, regarding an eccentricity of the optical device, there is proposed a compensation method to compensate for the effect of an eccentricity of the optical device which makes use of a mechanism to change a configuration of a mirror mounted in an optical system (e.g., Japanese Patent Laid-Open No. 2003-287612 and Japanese Patent Laid-Open No. 2005-49598).

Driving force generated by a small motor is ordinarily used as a source of driving force for changing a position of an optical device or an image taking device. However, the means by a small motor is unsuitable to significantly reduce size of an image taking apparatus due to technical difficulties. As a result, this means by a small motor can not satisfy the recent requirement in the field of image taking apparatuses for a smaller-sized image taking apparatus. On the other hand, it is disadvantageous in view of reduction in size and manufacturing cost to change a shape of a mirror to be mounted in an image taking apparatus in order to compensate for the effect of an eccentricity of the optical device, because the mounted mechanism is not needed any more after adjustment of the eccentricity.

### SUMMARY OF THE INVENTION

The present invention has been made in view of the above circumstances, and provides a camera shake compensation unit, an image taking apparatus, an image taking system and a method of compensating for an image formation position which are suitable for miniaturization.

The present invention provides a camera shake compensation unit including:

(1) a mobile optical device which allows light incident from a subject to run through the mobile optical device and changes the direction of the light by moving on a two-dimensional plane which intersects with the direction along the light;

(2) a camera shake detection section which detects a camera shake;

(3) a polymer actuator having:
(i) a polymer membrane which expands and contracts in response to application of a voltage, and connects the mobile optical device with a holding section, which is disposed away from the mobile optical device, for holding the mobile optical device; and
(ii) a plurality of electrodes for application of a voltage to parts of the polymer membrane which are disposed apart on the polymer membrane in contact with the polymer membrane; and

(4) a camera shake compensation section which compensates for displacement of light incident from a subject caused by a camera shake, by supplying a voltage corresponding to a detection result by the camera shake detection section to the plurality of electrodes in order to move the mobile optical device on the two-dimensional plane.

The first camera shake compensation unit according to the present invention can carry out compensation for a camera shake by moving the mobile optical device on the plane which intersects with the direction along light incident from a subject only using application of a voltage to the polymer actuator. The mechanism to compensate for a camera shake is so simple that the first camera shake compensation unit according to the present invention is appropriate for realizing smaller size.

The present invention also provides a camera shake compensation unit including:

(1) a mobile optical device which allows light incident from a subject to run through the mobile optical device and changes the direction of the light by tilting toward the direction along the light;

(2) a camera shake detection section which detects a camera shake;

(3) polymer actuators having:
(i) a plurality of polymer membranes each of which expands and contracts in response to application of a voltage, and extends in the direction of light incident from a subject, while one edge of the polymer membrane being kept fixed on the mobile optical device; and
(ii) a plurality of electrodes each of which is disposed on each of the plurality of polymer membranes for application of a voltage to each of the plurality of polymer membranes; and

(4) a camera shake compensation section which compensates for displacement of light incident from a subject caused by a camera shake, by supplying a voltage corresponding to a detection result by the camera shake detection section to the plurality of electrodes in order to tilt the mobile optical device.

The second camera shake compensation unit according to the present invention can carry out compensation for a camera shake by tilting the mobile optical device on the plane which intersects with the direction along light incident from a subject only using application of a voltage to the polymer actuator. The mechanism to compensate for a camera shake is so simple that the second camera shake compensation unit according to the present invention is also appropriate for realizing smaller size.

The present invention also provides a camera shake compensation unit including:

(1) a mobile optical device which allows light incident from a subject to run through the mobile optical device and changes the direction of the light by tilting toward the direction along the light;

(2) a camera shake detection section which detects a camera shake;

(3) a polymer actuator having:
(i) a plurality of polymer membranes which expand and contract in response to application of a voltage, and are disposed apart in the direction of light incident from a subject and connect the mobile optical device with a holding section for holding the mobile optical device which is disposed away from the mobile optical device; and
(ii) a plurality of electrodes for application of a voltage to parts of the polymer membranes which are disposed apart on the polymer membranes in contact with the polymer membranes;

(4) a camera shake compensation section which compensates for displacement of light incident from a subject caused by a camera shake, by supplying a voltage corresponding to a detection result by the camera shake detection section to the plurality of electrodes in order to tilt the mobile optical device.

The third camera shake compensation unit according to the present invention can carry out compensation for a camera shake by tilting the mobile optical device on the plane which intersects with the direction along light incident from a subject only using application of a voltage to the polymer actuator. The mechanism to compensate for a camera shake is so simple that the third camera shake compensation unit according to the present invention is also appropriate for realizing smaller size.

Also, in the first, second and third camera shake compensation units according to the present invention, preferably the mobile optical device is a lens.

The preferred forms of the camera shake compensation units can easily carry out compensation for a camera shake by driving the lens only using application of a voltage to the polymer actuator.

Also, the first and third camera shake compensation units according to the present invention, preferably includes:

an optical membrane which is a membrane made of a transparent material that light runs through, the optical membrane configured as:
(1) being attached on a surface of the mobile optical device through which light incident from a subject runs; and
(2) having at least a part thereof which is not attached on the mobile optical device and is integrated with the polymer membrane.

The preferred forms of the camera shake compensation units do not need a holder and something like that which hold the mobile optical device. As a result, the structure of these preferred forms of the camera shake compensation units is simplified.

Also, in the first and third camera shake compensation units according to the present invention, preferably the mobile optical device is an optical wedge.

The preferred forms of the camera shake compensation units can easily carry out compensation for a camera shake by driving the optical wedge only using application of a voltage to the polymer actuator.

The present invention also provides a camera shake compensation unit including:

(1) an image taking device which receives light incident from a subject and generates image signals, and changes a position of receiving the light by moving on a two-dimensional plane which intersects with the direction along the light;

(2) a camera shake detection section which detects a camera shake;

(3) a polymer actuator having:
(i) a polymer membrane which expands and contracts in response to application of a voltage, and connects the image taking device with a holding section for holding the image taking device which is disposed away from the image taking device: and
(ii) a plurality of electrodes for application of a voltage to parts of the polymer membrane which are disposed apart on the polymer membrane in contact with the polymer membrane; and

(4) a camera shake compensation section which compensates for displacement of light incident from a subject caused by a camera shake, by supplying a voltage corresponding to a detection result by the camera shake detection section to the plurality of electrodes in order to move the image taking device on the two-dimensional plane.

The fourth camera shake compensation unit according to the present invention can carry out compensation for a camera shake by moving the mobile image taking device on the plane which intersects with the direction along light incident from a subject only using application of a voltage to the polymer actuator. The mechanism to compensate for a camera shake is so simple that the fourth camera shake compensation unit according to the present invention is also appropriate for realizing smaller size.

Also, in the first and fourth camera shake compensation units according to the present invention, preferably the camera shake compensation section applies a voltage of a value corresponding to the detected result of the camera shake detection section.

The preferred forms of the camera shake compensation units can carry out compensation for a camera shake by applying an appropriate voltage corresponding to the detected result of the camera shake detection section.

Also, in the first and fourth camera shake compensation units according to the present invention, preferably the camera shake compensation section supplies pulse voltages of a pulse width corresponding to the detected result of the camera shake detection section.

Many polymer actuators are luck of ability to quickly respond to an applied voltage. It is available to use pulse voltages as a voltage applied to these polymer actuators whose pulse width is much shorter than the response time of these polymer actuators because these polymer actuators feel an effectively averaged voltage of pulse voltages by the response time. Moreover, it is also possible to change the averaged voltage by controlling the pulse width. Therefore the above preferred forms of the camera shake compensation units can carry out compensation for a camera shake by applying an effectively appropriate voltage corresponding to detected results of the camera shake detection section.

Also, in the first and fourth camera shake compensation units according to the present invention, preferably the polymer membrane expands and contracts as much as an amount corresponding to an average of an applied voltage in the case that the applied voltage is varied with passage of time.

The preferred forms of the camera shake compensation units can easily carry out compensation for a camera shake by applying an appropriate voltage obtained by averaging an applied voltage corresponding to a camera shake, even if the an applied voltage changes with passage of time.

Also, in the first and fourth camera shake compensation units according to the present invention, preferably the polymer membrane expands and contracts in response to release of an applied voltage, and the camera shake compensation section releases a voltage supplied to the electrodes for a compensation for a camera shake, instead of supplying a voltage.

The preferred forms of the camera shake compensation units can easily carry out compensation for a camera shake by releasing an appropriate voltage corresponding to a camera shake.

The present invention also provides an image taking apparatus which shoots a subject including:

(1) a mobile optical device which allows light incident from a subject to run through the mobile optical device and changes the direction of the light by moving on a two-dimensional plane which intersects with the direction along the light;

(2) a camera shake detection section which detects a camera shake;

(3) a polymer actuator having:
(i) a polymer membrane which expands and contracts in response to application of a voltage, and connects the mobile optical device with a holding section for holding the mobile optical device which is disposed away from the mobile optical device; and
(ii) a plurality of electrodes for application of a voltage to parts of the polymer membrane which are disposed apart on the polymer membrane in contact with the polymer membrane;

(4) a camera shake compensation section which compensates for displacement of light incident from a subject caused by a camera shake, by supplying a voltage corresponding to a detection result by the camera shake detection section to the plurality of electrodes in order to move the mobile optical device on the two-dimensional plane.

The first image taking apparatus according to the present invention can carry out compensation for a camera shake by moving the mobile optical device on the plane which intersects with the direction along light incident from a subject only using application of a voltage to the polymer actuator. The mechanism to compensate for a camera shake is so simple that the first image taking apparatus according to the present invention is appropriate for realizing smaller size.

The present invention also provides an image taking apparatus which shoots a subject including:

(1) a mobile optical device which allows light incident from a subject to run through the mobile optical device and changes the direction of the light running through the mobile optical device by tilting toward the direction along the light;

(2) a camera shake detection section which detects a camera shake;

(3) polymer actuators having:
(i) a plurality of polymer membranes each of which expands and contracts in response to application of a voltage, and extends in the direction of light incident from a subject, keeping a part of its edge fixed on the mobile optical device; and
(ii) a plurality of electrodes each of which is disposed on each of the plurality of polymer membranes for application of a voltage to each of the plurality of polymer membranes;

(4) a camera shake compensation section which compensates for displacement of light incident from a subject caused by a camera shake, by supplying a voltage corresponding to a detection result by the camera shake detection section to the plurality of electrodes in order to tilt the mobile optical device.

The second image taking apparatus according to the present invention can carry out compensation for a camera shake by tilting the mobile optical device on the plane which intersects with the direction along light incident from a subject only using application of a voltage to the polymer actuator. The mechanism to compensate for a camera shake is so simple that the second image taking apparatus according to the present invention is also appropriate for realizing smaller size.

The present invention also provides an image taking apparatus which shoots a subject including:

(1) a mobile optical device which allows light incident from a subject to run through the mobile optical device and changes the direction of the light running through the mobile optical device by tilting toward the direction along the light;

(2) a camera shake detection section which detects a camera shake;

(3) a polymer actuator having:
(i) a plurality of polymer membranes which expand and contract in response to application of a voltage, and are disposed apart in the direction of light incident from a subject and connect the mobile optical device with a holding section for holding the mobile optical device which is disposed away from the mobile optical device; and
(ii) a plurality of electrodes for application of a voltage to parts of the polymer membranes which are disposed apart on the polymer membranes in contact with the polymer membranes;

(4) a camera shake compensation section which compensates for displacement of light incident from a subject caused by a camera shake, by supplying a voltage corresponding to a detection result by the camera shake detection section to the plurality of electrodes in order to tilt the mobile optical device.

The third image taking apparatus according to the present invention can carry out compensation for a camera shake by tilting the mobile optical device on the plane which intersects with the direction along light incident from a subject only using application of a voltage to the polymer actuator. The mechanism to compensate for a camera shake is so simple that the third image taking apparatus according to the present invention is also appropriate for realizing smaller size.

The present invention also provides an image taking apparatus which shoots a subject including:

(1) an image taking device which receives light incident from a subject and generates image signals, and changes a position of receiving the light by moving on a two-dimensional plane which intersects with the direction along the light;

(2) a camera shake detection section which detects a camera shake;

(3) a polymer actuator having:
(i) a polymer membrane which expands and contracts in response to application of a voltage, and connects the image taking device with a holding section for holding the image taking device which is disposed away from the image taking device; and
(ii) a plurality of electrodes for application of a voltage to parts of the polymer membrane which are disposed apart on the polymer membrane in contact with the polymer membrane;

(4) a camera shake compensation section which compensates for displacement of light incident from a subject caused by a camera shake, by supplying a voltage corresponding to a detection result by the camera shake detection section to the plurality of electrodes in order to move the image taking device on the two-dimensional plane.

The fourth image taking apparatus according to the present invention can carry out compensation for a camera shake by moving the mobile image taking device on the plane which intersects with the direction along light incident from a subject only using application of a voltage to the polymer actuator. The mechanism to compensate for a camera shake is so simple that the first image taking apparatus according to the present invention is also appropriate for realizing smaller size.

The present invention also provides an image taking system having:

(1) an image taking apparatus which forms an image based on light incident from a subject and generates image signals which represent the subject image; and

(2) an image formation position compensation unit which is mounted on the image taking apparatus removably and control the image taking apparatus to compensate for displacement of image formation position of the light,

the image taking system including:

(A) an image taking apparatus including;

(1) a mobile optical device which allows light incident from a subject to run through the mobile optical device and changes the direction of the light running through the mobile optical device by moving on a two-dimensional plane which intersects with the direction along the light;
(2) a polymer actuator having:
   (i) a polymer membrane which expands and contracts in response to application of a voltage, and connects the mobile optical device with a holding section for holding the mobile optical device which is disposed away from the mobile optical device; and
   (ii) a plurality of electrodes for application of a voltage to parts of the polymer membrane which are disposed apart on the polymer membrane in contact with the polymer membrane;
(3) a connection section on which the image formation position compensation unit is mounted removably; and
   (B) an image formation position compensation unit including a displacement compensation section which recognizes an amount of displacement of image formation position of light incident from a subject and compensates for the displacement of the image formation position of the light by supplying a voltage corresponding to the amount of the displacement to the plurality of electrodes in order to move the mobile optical device on the two-dimensional plane.

The image taking system according to the present invention can carry out compensation for displacement of an image formation position by moving the mobile optical device on the plane which intersects with the direction along light incident from a subject only using application of a voltage to the polymer actuator. The mechanism to compensate for displacement of an image formation position is so simple and the polymer actuator is so cheap that the first image taking system according to the present invention is appropriate for realizing smaller size and lower cost.

Also, in the image taking system according to the present invention, preferably the mobile optical device is a lens.

The preferred forms of the image taking system can easily carry out compensation for displacement of an image formation position by driving the lens only using application of a voltage to the polymer actuator.

Also, the image taking system and the image taking system with the lens as the mobile optical device according to the present invention, preferably includes:

an optical membrane which is a membrane made of a transparent material that light runs through, the optical membrane configured as:
(1) being attached on a surface of the mobile optical device through which light incident from a subject runs; and
(2) having at least a part thereof which is not attached on the mobile optical device and is integrated with the polymer membrane.

The preferred forms of the image taking systems do not need a holder and something like that which hold the mobile optical device. As a result, the structure of these preferred forms of the image taking systems is simplified.

Also, in the image taking system according to the present invention, preferably the image taking apparatus includes:

an image signal generation section which generates image signals by receiving light incident from a subject which runs through the mobile optical device;

the image taking system further including:

a displacement calculation section which calculates an amount of displacement of image formation position of light incident from a subject based on the image signal; and

the displacement compensation section recognizing the amount of displacement of image formation position by obtaining the amount of displacement of image formation position calculated by the displacement calculation section.

The preferred forms of the image taking system can easily carry out compensation for displacement of an image formation position by calculating an amount of displacement of an image formation position of light incident from a subject from image signals.

Also, in the image taking system according to the present invention, preferably the displacement compensation section applies a voltage of a value corresponding to the amount of displacement of image formation position.

The preferred form of the image taking system can carry out compensation for displacement of an image formation position by applying an appropriate voltage corresponding to an amount of displacement of an image formation position.

Also, in the image taking system according to the present invention, preferably the displacement compensation section supplies pulse voltages of a pulse width corresponding to the amount of displacement of image formation position.

Many polymer actuators are luck of ability to quickly respond to an applied voltage. It is available to use pulse voltages as a voltage applied to these polymer actuators whose pulse width is much shorter than the response time of these polymer actuators because these polymer actuators feel an effectively averaged voltage of pulse voltages by the response time.

Moreover, it is also possible to change the averaged voltage by controlling the pulse width. Therefore the above preferred form of the image taking system can carry out compensation for displacement of an image formation position by applying an effectively appropriate voltage corresponding to an amount of displacement of an image formation position.

Also, in the image taking system according to the present invention, preferably the image taking apparatus comprising a position fixing section which fixes the mobile optical device on position where displacement of the image formation position is compensated.

In the preferred form of the image taking system, it is possible to fix the mobile optical device on the appropriate position to compensate for displacement of an image formation position even after the application of a voltage to the polymer actuator is stopped. In addition to that, there is another merit that the polymer actuator is useful as a damper due to its elasticity for impact on the image taking system from outside when the image taking system is used, even though the role of polymer actuator has already finished after the fixing the mobile optical device. As a result, the polymer actuator produces an effect to reduce the damage of the mobile optical device originated from the impact.

Also, in the image taking system according to the present invention and the image taking system in which pulse voltages are applied according to the present invention, preferably the polymer membrane expands and contracts as much as an amount corresponding to an average of an applied voltage in the case that the applied voltage is varied with passage of time.

The preferred forms of the image taking systems can easily carry out compensation for displacement of an image formation position by applying an appropriate voltage obtained by averaging an applied voltage corresponding to displacement of an image formation position, even if the an applied voltage varies with passage of time.

Also, in the image taking system according to the present invention, preferably the polymer membrane expands and contracts in response to release of an applied voltage, and the displacement compensation section releases a voltage supplied to the electrodes for a compensation for displacement of the image formation position.

The preferred form of the image taking system can easily carry out compensation for displacement of an image formation position by releasing an appropriate voltage corresponding to displacement of an image formation position.

The present invention also provides a compensation method of image formation position of light incident from a subject in an image taking apparatus which forms an image based on light incident from a subject and generates image signals which represent the subject image, the compensation method of image formation position including:

(1) recognizing an amount of displacement of image formation position of light incident from a subject;

(2) compensating for the displacement of the image formation position of the light using a polymer actuator, the polymer actuator having;

(i) a polymer membrane which expands and contracts in response to application of a voltage, and connects the mobile optical device with a holding section for holding the mobile optical device which is disposed away from the mobile optical device; and
(ii) a plurality of electrodes for application of a voltage to parts of the polymer membrane which are disposed apart on the polymer membrane in contact with the polymer membrane;
   by supplying a voltage corresponding to the amount of the displacement recognized in the recognizing to the plurality of electrodes in order to move the mobile optical device on the two-dimensional plane.
   (3) fixing the mobile optical device on position where displacement of the image formation position is compensated.

The compensation method of image formation position according to the present invention can carry out compensation for displacement of an image formation position by moving the mobile optical device on the plane which intersects with the direction along light incident from a subject only using application of a voltage to the polymer actuator. Then, the mobile optical device is fixed on the appropriate position to compensate for displacement of an image formation position. The mechanism to compensate for displacement of an image formation position is so simple and the polymer actuator is so cheap that the first image taking system according to the present invention is appropriate for realizing smaller size and lower cost. In addition to that, there is another merit that the polymer actuator is useful as a damper due to its elasticity for impact on the image taking system from outside when the image taking system is used, even though the role of polymer actuator has already finished after the fixing the mobile optical device. As a result, the polymer actuator produces an effect to reduce the damage of the mobile optical device originated from the impact.

The present invention provides a camera shake compensation unit including:

(1) an image taking device which receives light incident from a subject and generates image signals, and changes a position of receiving the light by rotating on a two-dimensional plane which intersects with the direction along the light;

(2) a camera shake detection section which detects a camera shake;

(3) a polymer actuator having:
(i) a polymer membrane which expands and contracts in response to application of a voltage, and connects the image taking device with a holding section for holding the image taking device which is disposed away from the image taking device; and
(ii) a plurality of electrodes for application of a voltage to parts of the polymer membrane which are disposed apart on the polymer membrane in contact with the polymer membrane;

(4) a camera shake compensation section which compensates for displacement of light incident from a subject caused by a camera shake, by supplying a voltage corresponding to a detection result by the camera shake detection section to the plurality of electrodes in order to rotate the image taking device on the two-dimensional plane.

The fifth camera shake compensation unit according to the present invention can carry out compensation for a camera shake which causes rotation of a subject image by rotating the mobile image taking device on the plane which intersects with the direction along light incident from a subject only using application of a voltage to the polymer actuator. The mechanism to compensate for a camera shake is so simple that the fifth camera shake compensation unit according to the present invention is appropriate for realizing smaller size.

Also, in the fifth camera shake compensation unit according to the present invention, preferably the camera shake compensation section compensates for displacement of light incident from a subject caused by a camera shake, by supplying a voltage corresponding to a detection result by the camera shake detection section to the plurality of electrodes in order to shift and rotate the image taking device on the two-dimensional plane.

The preferred form of the camera shake compensation units can easily carry out compensation for a camera shake which causes rotation and shift of a subject image only by using application of a voltage to the polymer actuator.

Also, in the fifth camera shake compensation unit according to the present invention, preferably the camera shake compensation section applies a voltage of a value corresponding to the detected result of the camera shake detection section.

The preferred form of the camera shake compensation unit can carry out compensation for a camera shake by applying an appropriate voltage corresponding to detected results of the camera shake detection section.

Also, in the fifth camera shake compensation unit according to the present invention, preferably the camera shake compensation section supplies pulse voltages of a pulse width corresponding to the detected result of the camera shake detection section.

Many polymer actuators are luck of ability to quickly respond to an applied voltage. It is available to use pulse voltages as a voltage applied to these polymer actuators whose pulse width is much shorter than the response time of these polymer actuators because these polymer actuators feel an effectively averaged voltage of pulse voltages by the response time. Moreover, it is also possible to change the averaged voltage by controlling the pulse width. Therefore the above preferred form of the camera shake compensation unit can carry out compensation for a camera shake by applying an effectively appropriate voltage corresponding to detected results of the camera shake detection section.

Also, in the fifth camera shake compensation unit according to the present invention, preferably the polymer membrane expands and contracts as much as an amount corresponding to an average of an applied voltage in the case that the applied voltage is varied with passage of time.

The preferred form of the camera shake compensation unit can easily carry out compensation for a camera shake by applying an appropriate voltage obtained by averaging an applied voltage corresponding to a camera shake, even if the an applied voltage changes with passage of time.

Also, in the fifth camera shake compensation unit according to the present invention, preferably the polymer membrane expands and contracts in response to release of an applied voltage, and the camera shake compensation section releases a voltage supplied to the electrodes for a compensation for a camera shake, instead of supplying a voltage.

The preferred form of the camera shake compensation unit can easily carry out compensation for a camera shake by releasing an appropriate voltage corresponding to a camera shake.

The present invention also provides an image taking apparatus which shoots a subject including:

(1) an image taking device which receives light incident from a subject and generates image signals, and changes a position of receiving the light by rotating on a two-dimensional plane which intersects with the direction along the light;

(2) a camera shake detection section which detects a camera shake;

(3) a polymer actuator having:
(i) a polymer membrane which expands and contracts in response to application of a voltage, and connects the image taking device with a holding section for holding the image taking device which is disposed away from the image taking device; and
(ii) a plurality of electrodes for application of a voltage to parts of the polymer membrane which are disposed apart on the polymer membrane in contact with the polymer membrane;

(4) a camera shake compensation section which compensates for displacement of light incident from a subject caused by a camera shake, by supplying a voltage corresponding to a detection result by the camera shake detection section to the plurality of electrodes in order to rotate the image taking device on the two-dimensional plane.

The fifth image taking apparatus according to the present invention can carry out compensation for a camera shake which causes rotation of a subject image by rotating the mobile image taking device on the plane which intersects with the direction along light incident from a subject only using application of a voltage to the polymer actuator. The mechanism to compensate for a camera shake is so simple that the first image taking apparatus according to the present invention is appropriate for realizing smaller size.

As described above, the present invention provides a camera shake compensation unit, an image taking apparatus, an image taking system and a method of compensating for an image formation position which are suitable for miniaturization.

### BRIEF DESCRIPTION OF THE DRAWINGS

The invention will be described with reference to the accompanying figures of which:

FIG. 1 is an external perspective view of a digital camera to which a first embodiment of the present invention applies;

FIG. 2 is a schematic diagram showing an internal configuration of the digital camera shown in FIG. 1;

FIG. 3 shows the compensation lens shown in FIG. 2 and a mechanism to move this compensation lens;

FIG. 4 shows a structure to supply voltages to the four pairs of electrodes of the polymer actuator shown in FIG. 3;

FIG. 5 shows a sectional view of the compensation lens and the polymer actuator shown in FIG. 3;

FIG. 6 shows a sectional view of the compensation lens and the polymer actuator when the two electrodes shown in the left of FIG. 5 are supplied with a voltage;

FIG. 7 shows a structure of the external frame shown in FIG. 5 and FIG. 6;

FIG. 8 is a sectional view of the compensation lens directly connected with the polymer actuator;

FIG. 9 is a sectional view of a combination lens connected with the polymer actuator;

FIG. 10 shows the polymer actuator and the compensation lens which are fixed by an external frame whose cross section is circular;

FIG. 11 shows a mechanism to apply voltages of two stages of On and Off to the four pairs of electrodes;

FIG. 12 shows a sectional view of an optical wedge connected with the polymer actuators via the holder;

FIG. 13 shows a mechanism to rotate the compensation lens;

FIG. 14 shows a mechanism to rotate the compensation lens around both horizontal and vertical directions;

FIG. 15 shows a mechanism to rotate the compensation lens around both horizontal and vertical directions by four polymer actuators and four springs;

FIG. 16 is a schematic diagram showing an internal configuration of the digital camera in which compensation for a camera shake is carried out by driving a CCD;

FIG. 17 shows the CCD and a mechanism to drive this CCD;

FIG. 18 shows a sectional view of the CCD and the polymer actuator shown in FIG. 17;

FIG. 19 shows an external frame whose cross section perpendicular to light incident from a subject is circular in the embodiment in which compensation for a camera shake is carried out by driving the CCD;

FIG. 20 is a schematic diagram showing an internal configuration of the digital camera in the embodiment of the image taking system and an internal configuration of an eccentricity compensation apparatus which is connected with the digital camera;

FIG. 21 is a flowchart showing a flow of the eccentricity compensation operation.

FIG. 22 shows a mechanism to fix the compensation lens;

FIG. 23 shows the CCD and a mechanism to move this CCD;

FIG. 24 is a sectional view of the polymer actuator which shows a mechanism to apply a voltage to a part of the dielectric elastomer sandwiched between two anodes on the upper side and a cathode on the lower side;

FIG. 25 is a sectional view of the polymer actuator 2500 which shows a state in which a voltage is applied to a part of the dielectric elastomer in the FIG. 24 which is sandwiched between the left electrodes of the two electrodes on the upper side and the electrode on the lower side;

FIG. 26 is an external perspective view of the polymer actuator and the CCD with respect to the direction in which light incident from a subject comes in a state that a voltage is not applied;

FIG. 27 shows a state of the polymer actuator and the CCD when voltages are applied to two parts of the dielectric elastomer by using the electrodes which are on the left-lower position and on the right-upper position of the CCD;

FIG. 28 shows a state of the polymer actuator and the CCD when the voltage supplied to the electrode on the left-lower position of the CCD is larger than the voltage supplied to the electrode on the right-upper position of the CCD;

FIG. 29 is a sectional view of the polymer actuator which shows a mechanism to apply a voltage in the embodiment in which only a camera shake which causes rotation of a subject image is compensated for;

FIG. 30 shows a mechanism to apply voltages of two stages of On and Off to the four pairs of electrodes;

FIG. 31 shows the polymer actuator and the CCD which are fixed by an external frame whose cross section is circular;

### DETAILED DESCRIPTION OF THE INVENTION

### First Embodiment

The first embodiment of the present invention will be described below.

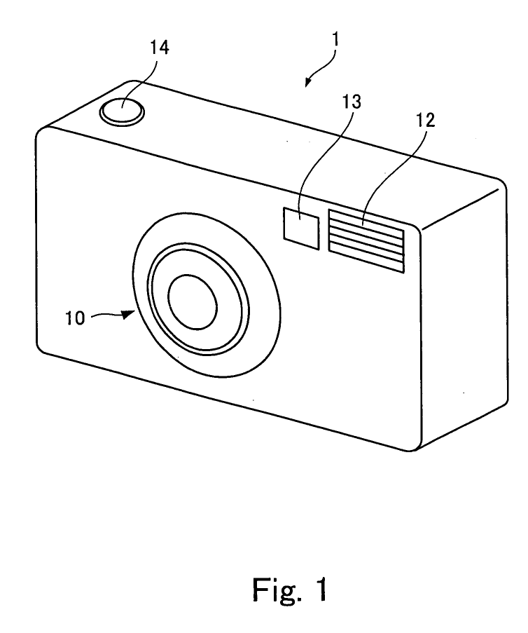

FIG. 1 is an external perspective view of a digital camera 1 to which the first embodiment of the present invention applies.

On the upper front part of the digital camera 1 shown in FIG. 1, there are an image taking lens 10 which condenses light incident from a subject, a flash emission section 12 which flashes, and a finder objective window 13. On the top face of the digital camera 1, there is a shutter button 14.

Various switches such as a zoom control switch and cross-key pad as well as an LCD (liquid crystal display) for use to display images and a menu screen are mounted on the back (not shown) of the digital camera.

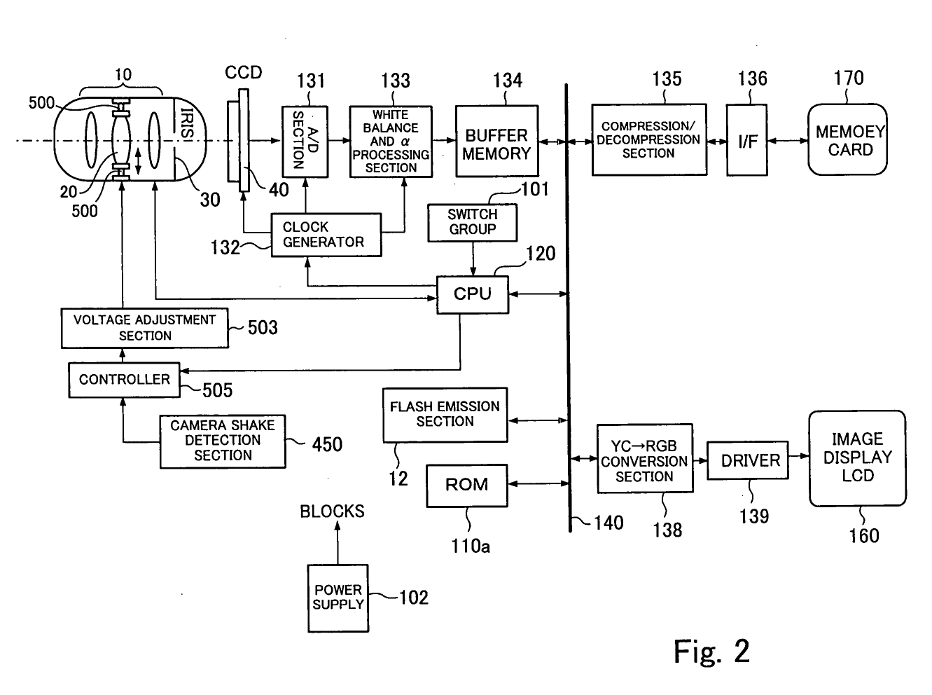

FIG. 2 is a schematic diagram showing an internal configuration of the digital camera 1 shown in FIG. 1.

The digital camera 1 has all its processes controlled by a CPU 120. The CPU 120 is supplied with operation signals from various switches (which include the shutter button 14 shown in FIG. 1, zoom control switch, and cross-key pad and will be referred to hereinafter collectively as a switch group 101) of the digital camera 1. The CPU 120 has a ROM 110a which contains various programs needed to run various processes on the digital camera 1. When a power switch (not shown) in the switch group 101 is turned on, power is supplied to various components of the digital camera 1 from a power supply 102 and then the CPU 120 totally controls the entire operation of the digital camera 1 according to the program procedures contained in the ROM 110a.

The configuration of the digital camera 1 is described below by explaining a flow of an image signal.

Light incident from a subject represented by a dotted line in the figure passes through the image taking lens 10 which consists of plural lenses, and an iris unit 30 and then forms an image on a CCD 40, which then generates an image signal representing a subject image.

A compensation lens 20 is included in the plural lenses constituting the image taking lens 10. As described later, compensation for a camera shake is carried out by moving the compensation lens 20 on the plane which is perpendicular to the direction along light incident from a subject, using a polymer actuator which is mounted near the compensation lens 20.

The generated image signal is roughly read by an A/D section 131, which then converts an analog signal into a digital signal to generate low-resolution live view data. The generated live view data are subjected to image processing such as white balance compensation and γ compensation by a white balance and γ processing section 133.

The CCD 40 generates the image signal at predetermined intervals in sync with a timing signal supplied from a clock generator 132. The clock generator 132 outputs the timing signal based on instructions transmitted from the CPU 120. In addition to the CCD 40, the timing signal is also supplied to the A/D section 131 and the white balance and γ processing section 133 in subsequent stages. Thus, the CCD 40, A/D section 131, and white balance and γ processing section 133 process the image signal in an orderly manner in sync with the timing signal generated by the clock generator 132.

After the image processing by the white balance and γ processing section 133, the image data are temporarily stored in a buffer memory 134. The low-resolution live view data stored in the buffer memory 134 are supplied to a YC/RGB conversion section 138 via the bus 140 in the order in which they are stored. The live view data are provided as RGB signals, and thus they are not processed by the YC/RGB conversion section 138. Instead, they are transmitted directly to an image display LCD 160 via a driver 139, and a live view from the live view data is displayed on the image display LCD 160. The CCD 40 reads light incident from a subject and generates an image signal at the predetermined intervals, and thus the light incident from a subject coming from the direction in which the image taking lens is directed is displayed constantly on the image display LCD 160.

The live view data stored in the buffer memory 134 are also supplied to the CPU 120. Based on the live view data, the CPU 120 carries out auto-focus process and automatic exposure adjustment.

When the user presses the shutter button 14 shown in FIG. 1 by checking the live view displayed on the image display LCD 160, the press of the shutter button 14 is transmitted to the CPU 120. If the light condition around the subject is dark, the CPU 120 gives an instruction for a flash to the flash emission section 12 and the flash emission section 12 flashes in sync with the press of the shutter button 14.

The digital camera 1 has a camera shake detection section 450 which detects a camera shake by measuring an angular frequency, a voltage adjustment section 503 which adjusts a voltage applied to the polymer actuator 500, a controller 505 which controls the voltage adjustment section 503. If a camera shake occurs at the moment when the shutter button 14 is pressed, the camera shake detection section 450 detects the camera shake and information about the camera shake is transmitted to the controller 505. Using a mechanism described later, the controller 505 compensates for the camera shake by moving the compensation lens 20 on the plane which is perpendicular to the direction along light incident from a subject.

When the image taking is carried out by pressing the shutter button 14, based on instructions from the CPU 120, the image signals generated by the CCD 40 are read out finely by the A/D section 131 to generate high-resolution photographic image data. The generated photographic image data is subjected to image processing by the white balance and γ processing section 133 and stored in the buffer memory 134.

The photographic image data stored in the buffer memory 134 is supplied to a YC processing section 137, where they are converted from an RGB signal to a YC signal. After the conversion into the YC signal, the photographic image data is subjected to a compression process by a compression/decompression section 135. The compressed photographic image data is stored in a memory card 170 via an interface 136.

The photographic image data stored in the memory card 170 is subjected to a decompression process by the compression/decompression section 135, converted into an RGB signal by the YC/RGB conversion section 138, and transmitted to the image display LCD 160 via the driver 139. The image display LCD 160 displays a photographic image represented by the photographic image data.

The digital camera 1 is configured as described above.

As described above, the digital camera 1 has a mechanism to compensate for a camera shake by moving the already-mentioned compensation lens 20 on the plane which is perpendicular to the direction along light incident from a subject if a camera shake is detected at the moment when the shutter button 14 is pressed. Details on the mechanism to compensate for a camera shake will be described below.

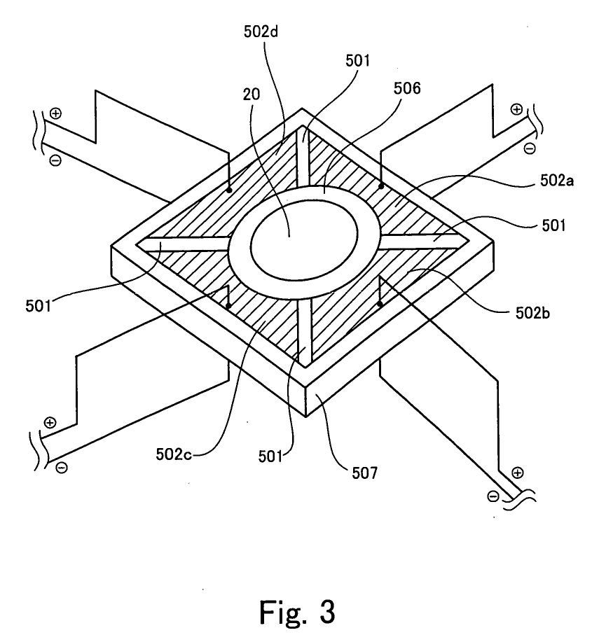

FIG. 3 shows the compensation lens 20 shown in FIG. 2 and a mechanism to move this compensation lens.

The digital camera 1 has the polymer actuator 500 to move this compensation lens 20 shown in FIG. 2. The polymer actuator 500 has a shape of a square with a round hole formed on its center by which a round holder 506 is surrounded. Also, an external frame 507 which is deposed around the polymer actuator 500 and fixes the external ends of the polymer actuator 500 thereto. A combination of the compensation lens 20 and the holder 506 is an example of the mobile optical device according to the present invention, and the external frame 507 is an example of the holding member according to the invention.

The polymer actuator 500 includes electrodes 502a, 502b, 502c, 502d and a dielectric elastomer 501 which is a kind of polymer material which has a property to expand and contract in response to application of a voltage. Each of electrodes 502a, 502b, 502c, 502d is made of carbon fiber with high conductivity and is put on the dielectric elastomer 501. There are four electrodes respectively on the upper and lower side of the polymer actuator 500. The four electrodes on the upper side are anodes and the four electrodes on the lower side are cathodes, that is, they constitute four pairs of electrodes in which an anode and a cathode constitute one pair. In this figure, the four anodes of the four pairs of electrodes 502a, 502b, 502c, 502d are shown on the upper side by diagonal lines. The dielectric elastomer 501 has a shape of a square with a round hole on its center by which the round holder 506 is surrounded. In FIG. 3, a part of the dielectric elastomer 501 appears between the respective two adjacent electrodes of the four electrodes 502a, 502b, 502c, 502d.

The above structure of the polymer actuator 500 makes it possible to apply voltages of different values to the respective four parts of the dielectric elastomer 501 sandwiched between the four electrodes on the upper side and the four electrodes on the lower side. Then a mechanism to apply voltages with different values to the four parts will be described below.

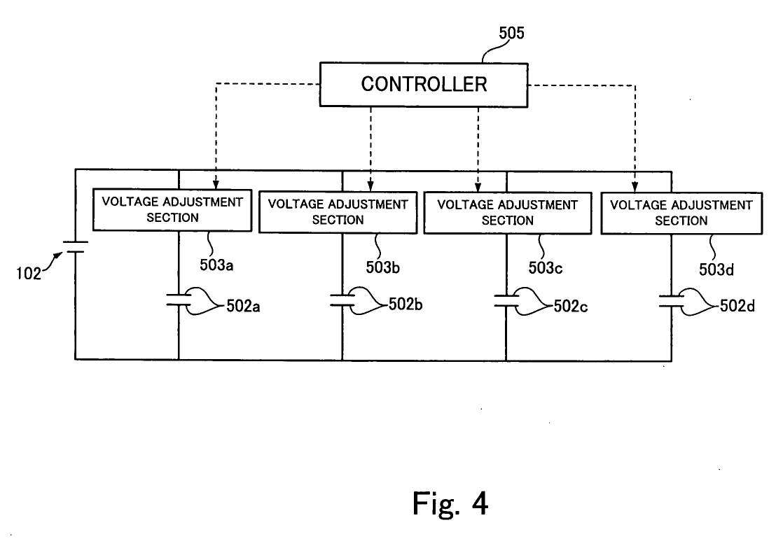

FIG. 4 shows a structure to supply voltages to the four pairs of electrodes of the polymer actuator 500 shown in FIG. 3.

In this structure, there are four sets which consist of four pairs of electrodes 502a, 502b, 502c, 502d and four voltage adjustment sections 503a, 503b, 503c, 503d in which one set consists of a pair of electrodes and a voltage adjustment section consists in one set, and the four sets are connected with the power 102 in parallel as shown in FIG. 4. Incidentally, the voltage adjustment section 503 shown in FIG. 2 represents the above four voltage adjustment sections 503a, 503b, 503c, 503d in an integrated form for depiction, and there actually exist four voltage adjustment sections, rather than one voltage adjustment section. These four voltage adjustment sections 503a, 503b, 503c, 503d respectively have roles to adjust a voltage applied to the corresponding pairs of electrodes of the four pairs of electrodes 502a, 502b, 502c, 502d, and are independently controlled by the controller 505. The structure as described above makes it possible to supply voltages of different values to the four pairs of electrodes 502a, 502b, 502c, 502d.

Incidentally, voltages are thus supplied by the power 102 in the embodiment. However, it may be possible to use high voltage supplied to the flash emission section 12.

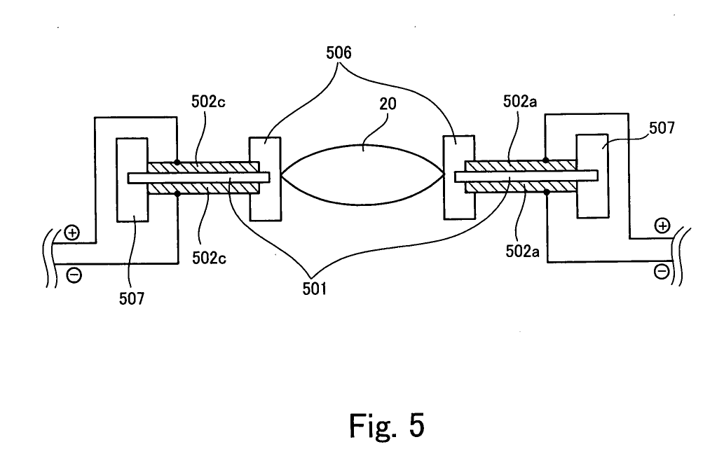

FIG. 5 shows a sectional view of the compensation lens 20 and the polymer actuator 500 shown in FIG. 3.

The two electrodes 502c in the left of FIG. 5 apply a voltage to a part of the dielectric elastomer 501 sandwiched between these electrodes 502c as shown in FIG. 5. In the same way, the two electrodes 502a in the right of FIG. 5 apply a voltage to a part of the dielectric elastomer 501 sandwiched between these electrodes 502a. FIG. 5 shows a state of the polymer actuator 500 in which any part of the dielectric elastomer 501 is not expanded without application of a voltage.

Next, description will be made of how the compensation lens 20 and the holder 506 are moved by application of a voltage to the polymer actuator 500 in order to compensate for a camera shake.

When a camera shake occurs and the camera shake detection section 450 in FIG. 2 detects the camera shake, the controller 505 calculates the distance and the direction for the compensation lens 20 to move in in order to compensate for the camera shake. Moreover, the controller 505 determines which pair of the electrodes a voltage should be supplied to and the value of the supplied voltage. Then, the controller 505 gives the respective four voltage adjustment sections 503a, 503b, 503c, 503d an instruction to supply a voltage of the determined value to the corresponding pair of electrodes. A combination of the controller 505 and the four voltage adjustment sections 503a, 503b, 503c, 503d is an example of the camera shake compensation section according to the present invention.

Description will be made below, as an example, on the supposition that the determination to supply a voltage to the two electrodes in the left of FIG. 5 is made because the compensation lens 20 is required to be moved from its position shown in FIG. 5 to the right in order to compensate for a camera shake.

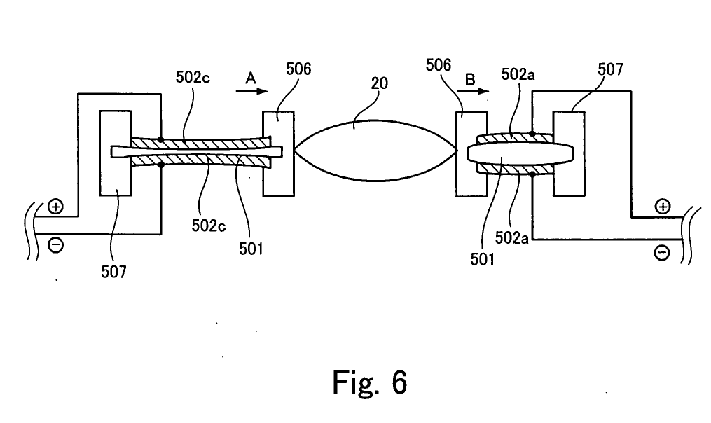

FIG. 6 shows a sectional view of the compensation lens 20 and the polymer actuator 500 when the two electrodes in the left of FIG. 5 are supplied with a voltage.

In general, a dielectric elastomer has a property that it expands in the direction along the electrodes which applies a voltage to the dielectric elastomer. The length of the expansion is longer as an applied voltage increases. On the other hand, the four pairs of electrodes 502a, 502b, 502c, 502d in the embodiment can expand and contract according to the expansion and contraction of the parts of dielectric elastomer 501 on which these pairs of electrodes are placed on when voltages are applied.

Because of the above mentioned property of a dielectric elastomer, a part of the dielectric elastomer 501 between the two electrodes expands from the state shown in the left of FIG. 5 to the direction of an arrow A in FIG. 6 as shown in this figure when the two electrodes in the left of FIG. 5 are supplied with a voltage. At that time, the expansion of the dielectric elastomer 501 generates driving force to push the compensation lens 20 and the holder 506 to the right of FIG. 5. The compensation lens 20 and the holder 506 pushed to the right is moved as a whole from the position shown in FIG. 5 to the right, while pressing in the direction of an arrow B in FIG. 6 a part of the dielectric elastomer 501 sandwiched between the two electrodes 502a shown in the right of FIG. 6. Such a movement of the lens 20 and the holder 506 compensates for the camera shake. After compensation for the camera shake, the state of the polymer actuator 500 returns to the state in FIG. 5 by stopping the application of a voltage.

Such application of a voltage is carried out to each part of the dielectric elastomer 501 which is sandwiched between the electrode on the upper side and the electrode on the lower side. As a result, the lens 20 and the holder 506 are moved on the plane which is perpendicular to the direction along light incident from a subject, and a camera shake is compensated by this movement.

As described above, the mechanism using the digital camera 1 enables driving the compensation lens 20 for compensation for a camera shake with the simpler configuration compared with conventional one using a compact motor, and thus enables realization of a smaller image taking apparatus.

The external frame 507 shown in FIG. 5 and FIG. 6 is configured to fix the external ends of the polymer actuator 500 such that the polymer actuator 500 can expand and contract for compensation for a camera shake. Description of a structure of the external frame 507 for the fixing will be made below.

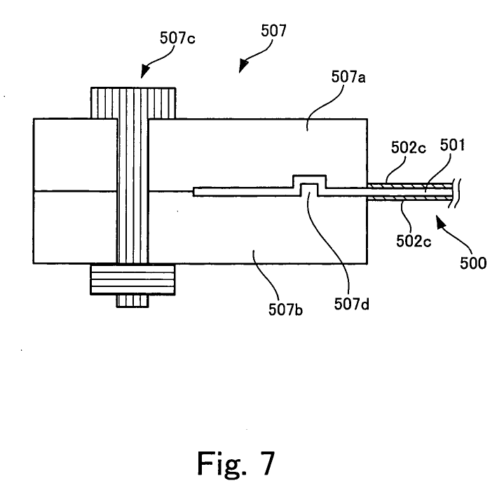

FIG. 7 shows a structure of the external frame shown in FIG. 5 and FIG. 6.

As shown in FIG. 7, the external frame 507 shown in FIG. 5 and FIG. 6 includes a pair of plates which consist of the first press plate 507a and the second press plate 507b which sandwich an end part of the polymer actuator 500 (more precisely, an end part of the dielectric elastomer 501). The external frame 507 also includes a screw 507c which keeps the first and second press plates 507a, 507b stuck on the end part of the polymer actuator 500 as shown in FIG. 7. There is a projection section 507d On the surface of the second press plate 507b which contacts the polymer actuator 500. On the hand, the first press plate 507a has a surface a structure which engages with the projection section 507d on the surface which contacts the polymer actuator 500. The first and second press plate 507a, 507b sandwiches the end part of the polymer actuator 500, keeping the polymer actuator 500 hooked by the projection section 507d. The screw 507c maintains this state by pressing the first and second press plate 507a, 507b on the end part of the polymer actuator 500.

Therefore, the end part of the polymer actuator 500 is tightly fixed, although the structure for fixing is very simple.

The description of the first embodiment of the present invention is completed above.

### Second Embodiment

In the first embodiment, the compensation lens 20 is connected with the polymer actuator 500 via the holder 506. However, the present invention is not limited to this method and the embodiment described above may employ another method in which a transparent dielectric elastomer that light easily runs through is used to connect the compensation lens 20 directly with the polymer actuator 500 without using the holder 506. Description of such an embodiment will be made below as the second embodiment. The following second embodiment is different from the first embodiment in a point that the compensation lens 20 is directly connected with the polymer actuator 500 without using the holder 506. Except this point, an external view, a structure and a mechanism to compensate for a camera shake of an image taking apparatus in the second embodiment are the same as those of the image taking apparatus in the first embodiment. Thus, the description below will focus on the point that the compensation lens 20 is directly connected with the polymer actuator 500 without repeating the same description which has been already made above.

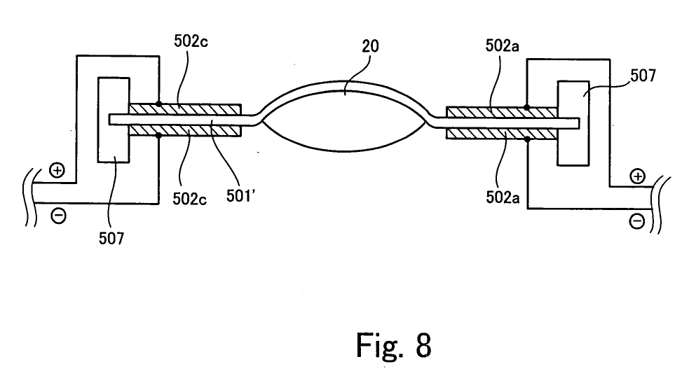

FIG. 8 is a sectional view which shows that the compensation lens is directly connected with the polymer actuator.

A dielectric elastomer 501′ used in the embodiment has excellent transparency and a part of the dielectric elastomer 501′ is attached on the surface of the compensation lens 20 as shown in FIG. 8. The dielectric elastomer 501′ which is stuck on the surface of the compensation lens 20 and holds the compensation lens 20 is an example of the optical membrane according to the present invention. In the second embodiment with the above structure, the compensation lens 20 is moved by expansion and contraction of the dielectric elastomer 501′. A mechanism to compensate for a camera shake by moving the compensation lens 20 when the camera shake occurs is the same as that of the first embodiment. Thus, the same description which has been already made in the previous embodiment will be omitted.

### Third Embodiment

In the first and second embodiments, the compensation lens 20 is a single lens. However, the present invention is not limited to this type and the embodiment described above may employ a combination lens to compensate for a camera shake. Description of such an embodiment will be made below as the third embodiment. The following third embodiment is different from the second embodiment in points that a compensation lens in the third embodiment is a combination lens and that another structure is provided to hold the combination lens besides the dielectric elastomer in order to support the increased weight of the compensation lens. Except these points, an external view, a structure and a mechanism to compensate for a camera shake of an image taking apparatus in the third embodiment are the same as those of the image taking apparatus in the second embodiment. Thus, the description below will focus on the different point without repeating the same description which has been already made above.

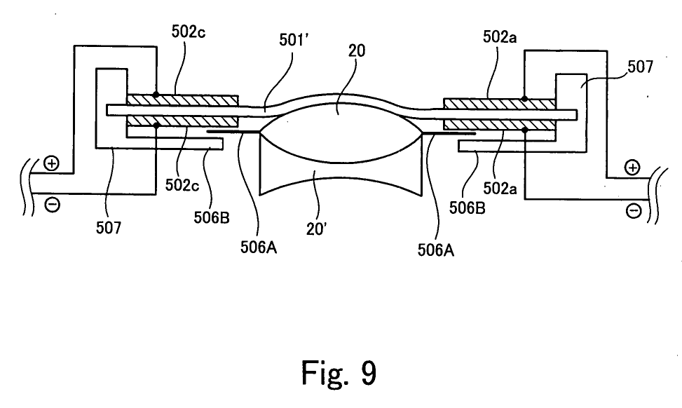

FIG. 9 is a sectional view which shows that a combination lens is connected with the polymer actuator.

As shown in FIG. 9, a combination lens to compensate for a camera shake which consists of two lenses 20, 20′ has the dielectric elastomer 501′ which is stuck on the surface of the upper lens 20 in the figure. Also, a brim 506A is mounted around the upper lens 20 and the brim 506A is inserted between a guide 506B which extends from the external frame 507 to the lens 20 and the lower electrodes 502a, 502c of the polymer actuator 500. This structure prevents the positions of the two lenses 20, 20′ from going down in the figure and supports the increased weight due to the increase in the number of lenses for the compensation lens.

### Fourth Embodiment

In the first to third embodiments described above, the external frame 507 to fix the polymer actuator has a square cross section with respect to the plane which is perpendicular to the direction along light incident from a subject. However, the present invention is not limited to this shape and the embodiments described above may employ an external frame whose cross section is circular. Description of such an embodiment will be made below as the fourth embodiment.

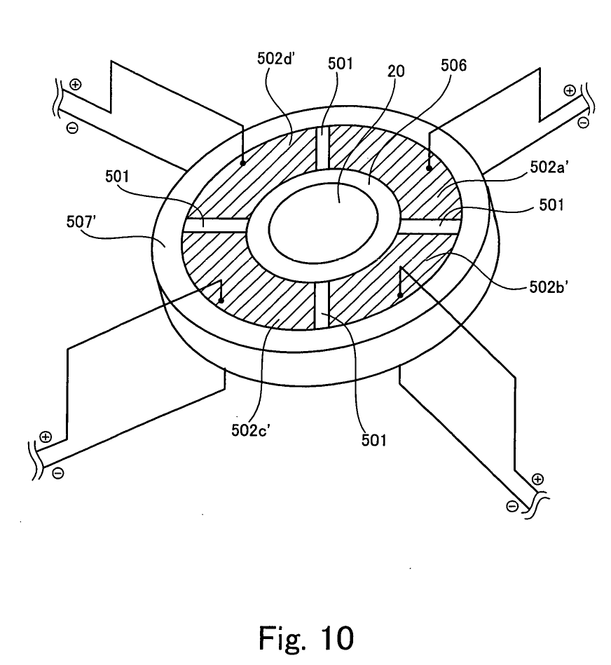

FIG. 10 shows the polymer actuator and the compensation lens which are fixed by an external frame whose cross section is circular.

Four pairs of electrodes in which one pair consists of an anode and a cathode are mounted in the fourth embodiment in the same way as the case shown in FIG. 3 in which the external frame whose cross section is square is used. Also, applications of voltages to the dielectric elastomer 501 between these pairs of electrodes is carried out in the same way as the case shown in FIG. 3. Except a point that the shape of the external frame 507′ is different, an external view, a structure and a mechanism to compensate for a camera shake of an image taking apparatus in the fourth embodiment are the same as those of the image taking apparatus in the first embodiment. Thus, the same description which has been already made in the first embodiment is omitted.

### Fifth Embodiment

In the first to fourth embodiments described above, the voltages to be supplied to the four pairs of electrodes to drive the polymer actuator is adjusted by adjustment of the values of the voltages. However, the present invention is not limited to this adjustment method and the embodiments described above may employ another adjustment method, for example, a so-called PWM control method in which adjustment of time intervals when a voltage is applied is carried out in order to control drive of a mobile optical device for compensation for a camera shake, although voltage application has only two stages of On and Off. Description of such an embodiment will be made below as the fifth embodiment.

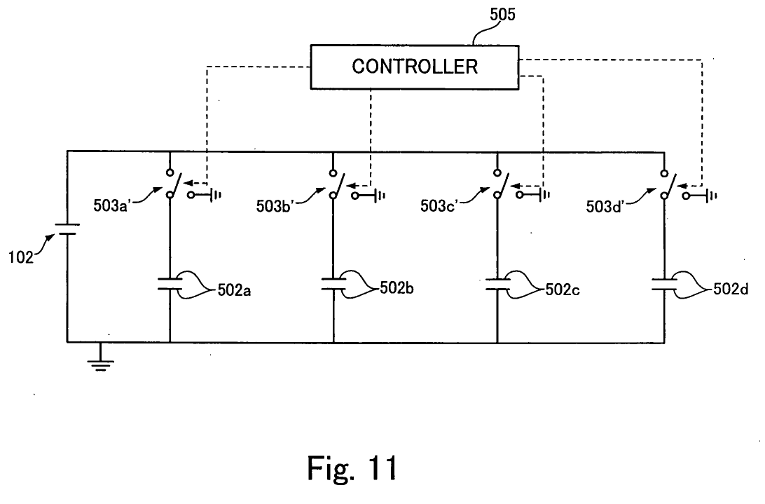

FIG. 11 shows a mechanism to apply voltages of two stages of On and Off to the four pairs of electrodes.

As shown in FIG. 11, there are mounted four switches 503a′, 503b′, 503c′, 503d′ instead of four voltage adjustment sections 503a, 503b, 503c, 503d in FIG. 4. These four switches determines which of the power 102 or the ground in FIG. 11 is electrically connected, by which turning on and off of voltage supply to the corresponding pair of electrodes is carried out. The switching is controlled by the controller 505. Although there are only two kinds of value for an applied voltage that are zero and the value of the supply voltage, the controller 505 can generate a periodic series of square-wave pulses of voltage by switching the two kinds of values of the voltage to be applied by controlling the switch. The period of the voltage generated by the controller 505 is so short compared with the response time of the dielectric elastomer 501 that the dielectric elastomer 501 feels effectively a constant voltage below the supply voltage which is obtained from an applied voltage averaged by the response time. The pulse width of the applied voltage (time intervals when a voltage is applied) determines the value of the effective voltage. As a result, the controller 505 can control the effective voltage by controlling the pulse width of the applied voltage which consists of a series of square-wave pulse voltages.

Incidentally, the method of controlling the pulse width of the applied voltage which consists of a series of square-wave pulse voltages is employed in order to control the effective voltage in the fifth embodiment. However, the present invention is not limited to this method and the embodiment described above may employ another method in which voltage is controlled by controlling a period of an applied voltage which consists of a series of square-wave pulse voltages.

Turning on and off of voltage application to the polymer actuator is carried out by the four switches in the fifth embodiment. However, the present invention is not limited to this and the embodiment described above may employ a circuit element such as a thyristor and a MOS-type FES which turns on and off the electric current in order to control turning on and off of a voltage applied to the polymer actuator 500.

Incidentally, voltages are supplied by the power 102 in the fifth embodiment. However, it may be possible to use high voltage supplied to the flash emission section 12.

Except a point that the CCD is driven under the control of the pulse width of a series of square-wave pulse voltages generated by the voltage application of two stages of On and Off, an external view, a structure and a mechanism to compensate for a camera shake of an image taking apparatus in the fifth embodiment are the same as those of the image taking apparatus in the first embodiment. Thus, the same description which has been already made above is omitted.

### Sixth Embodiment

In the first to fifth embodiments described above, compensation for a camera shake is carried out by changing the direction of light incident from a subject by moving the compensation lens on the plane which is perpendicular to the direction along light incident from a subject. However, the present invention is not limited to a lens for compensation for a camera shake and the embodiments described above may employ another type of optical device which can change the direction of light incident from a subject. Also, in order to compensate for a camera shake, it is also possible to employ another way to change the direction of light incident from a subject which is different from the way to move the optical device on the plane which is perpendicular to the direction along light incident from a subject. For example, besides a lens, it is also possible to employ an optical device such as an optical wedge to change the direction of light incident from a subject into the image taking apparatus and compensate for a camera shake by tilting the optical device. Description of an embodiment in which the mechanism for driving the compensation lens described in the first to fifth embodiments is applied to a mechanism for control of tilting the optical device to compensate for a camera shake will be made below as the sixth embodiment.

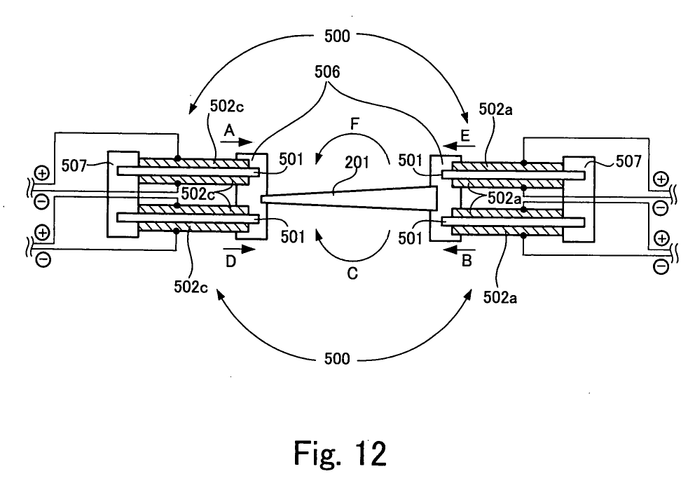

FIG. 12 shows a sectional view of an optical wedge connected with the polymer actuators via the holder.

As shown in FIG. 12, an optical wedge 201 to change the direction of light running into the image taking apparatus is fixed by the holder 506. In parallel with the optical wedge 201, there are two polymer actuators 500 (an upper polymer actuator 500 and a lower polymer actuator 500 in FIG. 12) which are disposed in such a manner that they surround the optical wedge 201.

When a camera shake occurs and the optical wedge 201 is driven to compensate for the camera shake, a voltage is applied to each of these polymer actuators 500 by making use of the structure to supply voltages in FIG. 4. In the embodiment, the voltage of the same value is concurrently applied to one of the electrodes of the upper polymer actuator 500 and one of the electrodes of the lower polymer actuator 500 in FIG. 12. More concretely, for example, when a voltage is applied to the left electrode 502c of the upper polymer actuator 500, the voltage of the same value is applied to the right electrode 502a of the lower polymer actuator 500. As a result, circumference of the left electrode 502c of the upper polymer actuator 500 expands in the direction of an arrow A shown in FIG. 12 and the circumference of the right electrode 502a of the lower polymer actuator 500 expands in the direction of an arrow B shown in FIG. 12. The optical wedge 201 rotates in the direction of an arrow C shown in FIG. 12 due to the torque generated on its both side. In the same way, the voltage of the same value is applied to each of the left electrode 502c of the lower polymer actuator 500 and the right electrode 502a of the upper polymer actuator 500. In this case, the circumference of the left electrode 502c of the lower polymer actuator 500 and the right electrode 502a of the upper polymer actuator 500 expands respectively in the directions of an arrow D and an arrow E shown in FIG. 12. At this time, the optical wedge 201 rotates in the direction of an arrow F shown in FIG. 12 due to the torque generated on its both side. The sixth embodiment is different from the first embodiment in a point that the optical wedge 201 is driven to rotate for compensation for a camera shake, instead of a compensation lens in the first embodiment. Except this point, an external view and a structure of an image taking apparatus in the sixth embodiment are the same as those of the image taking apparatus in the previous embodiments described in FIGS. 1-FIG. 4. Thus, the description which has been already made above will be omitted.

Incidentally, the optical wedge 201 is driven to rotate for compensation for a camera shake as an example in the sixth embodiment. However, if the embodiment described above employs a lens which is driven to rotate, it is possible to compensate for a camera shake in the same way as the above.

### Seventh Embodiment

Description of an embodiment in which the different mechanism of tilting an optical device from that of the sixth embodiment is used to compensate for a camera shake will be made below as the seventh embodiment. In this embodiment, a compensation for a camera shake by rotating the compensation lens 20 is described as an example.

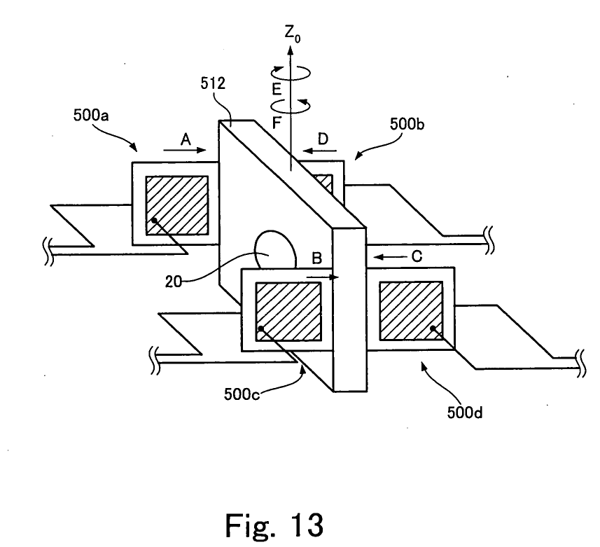

FIG. 13 shows a mechanism to rotate the compensation lens.

There are mounted four polymer actuators 500a, 500b, 500c, 500d two of which are placed two by two on two ends of a lens frame 512 respectively which extends in the upper and lower direction in FIG. 13. There is the compensation lens 20 held by the lens frame 512. Each of the four polymer actuators 500a, 500b, 500c, 500d is a square membrane whose side is fixed on an end of the lens frame 512. Moreover, the side of the square membrane which faces the fixed side on the end of the lens frame 512 is also fixed by a structure which is not shown in FIG. 13. Each of the four polymer actuators has the dielectric elastomer 501 sandwiched by two electrodes and one of the two electrodes on one side is shown by diagonal lines and in FIG. 13. Each of the four polymer actuators expands in response to application of a voltage in the direction in which its electrodes extend. Expansion of each polymer actuator pushes the end of the lens frame 512 on which each polymer actuator is fixed. In order that the lens frame 512 rotates around the Z0-axis in FIG. 13 which extends through the center of the lens frame 512, a voltage of the same value is applied on each of the two polymer actuators which are positioned opposite to each other with the Z0-axis between them. More concretely, for example, when a voltage is applied to the left polymer actuator 500a on the far side in FIG. 13, a voltage of the same value as that of the voltage is applied to the right polymer actuator 500d which is positioned opposite to the polymer actuator 500a with the Z0-axis between these two polymer actuators. In the same way, when a voltage is applied to the left polymer actuator 500c on this side in FIG. 13, a voltage of the same value as that of the voltage is applied to the right polymer actuator 500b which is positioned opposite to the polymer actuator 500a with the Z0-axis between them. A structure to supply voltages to each pair of electrodes of the four polymer actuators is the same as that of FIG. 4. Thus, the same description which has been already made in the previous embodiment will be omitted.

When a camera shake occurs and the camera shake detection section 450 in FIG. 2 detects the camera shake, the controller 505 calculates a rotational angle and its rotational direction that the compensation lens 20 should rotate in order to compensate for the camera shake. Moreover, the controller 505 determines which pair of electrodes a voltage should be applied to and the value of the applied voltage. Then the controller 505 gives the four voltage adjustment sections 503a, 503b, 503c, 503d in FIG. 4 an instruction to supply a voltage of the determined value to the corresponding pair of electrodes.

Description will be made below, as an example, on the supposition that determination to supply a voltage to the pair of electrodes of the left polymer actuator 500a on the far side and to the pair of electrodes of the right polymer actuator 500d on this side is made. The left polymer actuator 500a on the far side in FIG. 13 expands in the direction of an arrow A shown in this figure and the right polymer actuator 500d on this side in this figure expands in the direction of an arrow C shown in this figure. These two kinds of expansion generates torque which rotates the lens frame 512 around the Z0 axis shown in FIG. 13 in the direction of an arrow E. Due to the torque, compressing the right polymer actuator 500b on the far side in FIG. 13 and the left polymer actuator 500c on this side in this figure, the lens frame 512 rotates the lens frame 512 around the Z0 axis shown in this figure in the direction of an arrow E. After compensation for the camera shake, the state of the lens frame 512 returns from the rotated state to the original state shown in FIG. 13 by stopping the application of a voltage to the polymer actuator 500a and the polymer actuator 500c.

In the same way, when voltages of the same value are applied to the pair of electrodes of the left polymer actuator 500a on this side and to the pair of electrodes of the right polymer actuator 500d on the far side in FIG. 13, the left polymer actuator 500c on this side in this figure expands in the direction of an arrow B shown in this figure and the right polymer actuator 500d on the far side in this figure expands in the direction of an arrow D shown in this figure. As a result, the lens frame 512 rotates around the Z0 axis shown in the FIG. 13 in the direction of an arrow F.

In the embodiment, compensation for a camera shake with respect to the horizontal direction along a subject image (the direction of the line which extends between this side and the far side in FIG. 13) is carried out by using the above mechanism which rotates the lens frame 512 around the Z0 axis using voltage application to the four pairs of electrodes of the four polymer actuators 500a, 500b, 500c, 500d.

Except for a point that compensation for a camera shake is carried out by rotation of the lens frame 512, an external view and a structure of an image taking apparatus in the seventh embodiment are the same as those of the image taking apparatus in the previous embodiments described in FIGS. 1-FIG. 4. Thus, the description which has been already made above will be omitted.

Incidentally, the compensation lens 20 is driven to rotate for compensation for a camera shake as an example in the seventh embodiment. However if the embodiment described above employ an optical wedge to be driven to rotate, it is possible to compensate for a camera shake in the same way as the above.

Also in the seventh embodiment that compensation for a camera shake is carried out by rotation of the lens frame 512, it is possible to employ the method of controlling the pulse width of the applied voltage which is described in FIG. 11. But, the description which has been already made in FIG. 11 will be omitted.

### Eighth Embodiment

In the seventh embodiment, compensation for a camera shake with respect to the horizontal direction along a subject image (the direction of the line which extends between this side and the far side in FIG. 13) is carried out. However, it is also possible to compensate for a camera shake with respect to the vertical direction along a subject image (the direction of the line which extends between the upper side and the lower side in FIG. 13) by mounting additional four polymer actuators besides the four polymer actuators of the seventh embodiment. Description of such an embodiment will be made below as the eighth embodiment.

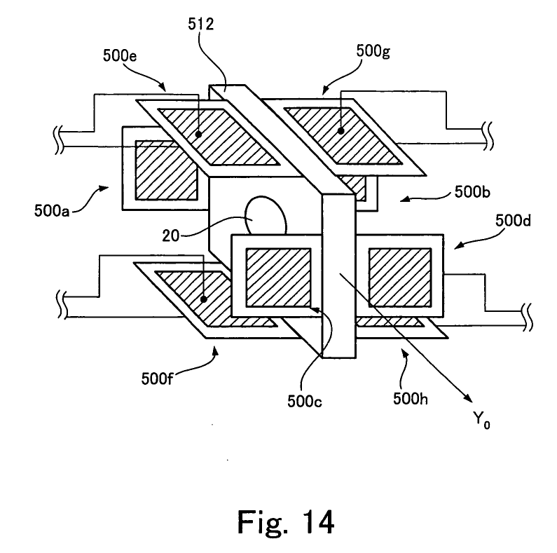

FIG. 14 shows a mechanism to rotate the compensation lens around both horizontal and vertical directions.

There are mounted additional four polymer actuators 500e, 500f, 500g, 500h besides the four polymer actuators 500a, 500b, 500c, 500d described in FIG. 13. Each of these additional four polymer actuators 500e, 500f, 500g, 500h has a surface which is perpendicular to those of the four polymer actuators 500a, 500b, 500c, 500d described in FIG. 13. In FIG. 14, depictions of electric wires shown in FIG. 13 which are connected with the four polymer actuators 500a, 500b, 500c, 500d are omitted.

By a mechanism to drive these additional four polymer actuators 500e, 500f, 500g, 500h in order to rotate the lens frame 512 around the Y0 axis which extends through the center of the lens frame 512, compensation for a camera shake with respect to the vertical direction along a subject image (the direction of the line which extends between the upper side and the lower side in FIG. 14) is carried out. The mechanism to drive the additional four polymer actuators is the same as that of the seventh embodiment and there is mounted the same electric circuit as that of FIG. 4 in order to apply voltages to the additional four polymer actuators 500e, 500f, 500g, 500h.

Except for a point that compensation for a camera shake is carried out by the two kinds of rotation of the lens frame 512 around the two axes, an external view and a structure of an image taking apparatus in the eighth embodiment are the same as those of the image taking apparatus in the previous embodiments described in FIGS. 1-FIG. 4. Thus, the description which has been already made above will be omitted.

Incidentally, the compensation lens 20 is driven to rotate for compensation for a camera shake as an example in the seventh embodiment. However if the embodiment described above employ an optical wedge as described in the fourth embodiment to be driven to rotate, it is possible to compensate for a camera shake in the same way as the above.

Also in the eighth embodiment that compensation for a camera shake is carried out by rotation of the lens frame 512, it is possible to employ the method of controlling the pulse width of the applied voltage which is described in FIG. 11. But, the description which has been already made in FIG. 11 will be omitted.

### Ninth Embodiment

In the above eighth embodiment, compensation for a camera shake with respect to horizontal and vertical directions along a subject image is carried out by the eight polymer actuators. However, the present invention is not limited to using eight polymer actuators and the embodiment described above may employ four polymer actuators and four springs to compensate for a camera shake with respect to horizontal and vertical directions along a subject image. Description of such an embodiment will be made below as a ninth embodiment.

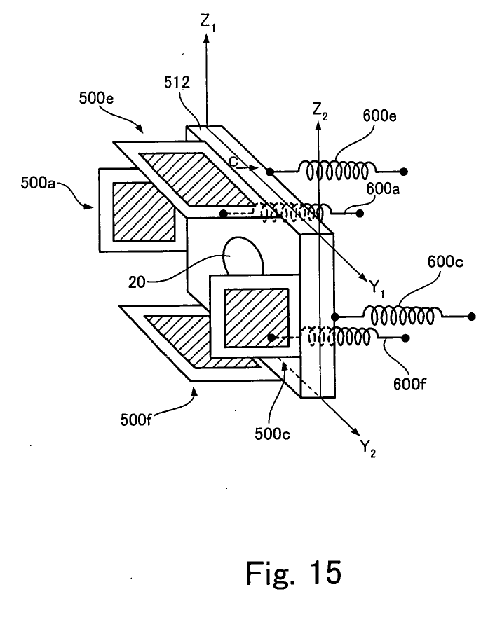

FIG. 15 shows a mechanism to rotate the compensation lens around both horizontal and vertical directions by four polymer actuators and four springs.

In the ninth embodiment, a structure in which the four polymer actuators on the right side of the eight polymer actuators shown in FIG. 14 are replaced with the four springs 600a, 600c, 600e, 600f is employed as shown in FIG. 15. Without application of voltage to the four polymer actuators on the left side, each length of the four springs is that of the state without burden and these four springs 600a, 600c, 600e, 600f have a role of a shock absorber to soften sudden rotation of the compensation lens 20 when voltages are applied. Application of voltages to these four polymer actuators is carried out by the same electric circuit as that of FIG. 4. In FIG. 15, depictions of electrical wires connected with pairs of electrodes of the polymer actuators are omitted. Different from the seventh and eighth embodiments, the four polymer actuators are mounted on one side (left side in FIG. 15) of the lens frame 512 in the ninth embodiment. A voltage is applied to only one of the polymer actuator 500a on the far side and the polymer actuator 500c on this side in FIG. 15 for compensation for a camera shake with respect to the horizontal direction. In the same way, a voltage is applied to only one of the polymer actuator 500e on the upper side and the polymer actuator 500c on the lower side in FIG. 15 for compensation for a camera shake with respect to the vertical direction. Description of the voltage application will be made as an example in the case that a voltage is applied to only a pair of electrodes of the polymer actuator 500e on the upper side in FIG. 15.

When a voltage is applied to only the pair of electrodes of the polymer actuator 500e on the upper side in FIG. 15, this polymer actuator 500e expands in the direction of an arrow C in this figure. In view of balance of a force, the lens frame 512 rotates in the direction of an arrow C in FIG. 15 around the Y2-axis in this figure which extends along the lower surface of the lens frame 512. At this time, the spring 600e, which is positioned opposite to the polymer actuator 500e with the lens frame 512 between them, softens sudden rotation of the lens frame 512 in the direction of an arrow C in FIG. 15 by its elastic force in the opposite direction to the expansion of the polymer actuator 500e which is generated by contracting shorter than the length of the state without burden.

In the same way, a compensation for a camera shake is carried out by rotating the lens frame 512 around the Y1-axis which extends along the upper surface of the lens frame 512, the Z1-axis which extends along the surface on the far side of the lens frame 512 and the Z2-axis which extends along the surface on this side of the lens frame 512, in the directions in which the polymer actuator expands respectively.

Except for a point that compensation for a camera shake is carried out by the four polymer actuators and the four springs, an external view, a structure and a mechanism to compensate for a camera shake of an image taking apparatus in the ninth embodiment are the same as those of the image taking apparatus in the first embodiment. Thus, the same description which has been already made above is omitted.

Incidentally, the compensation lens 20 is driven to rotate for compensation for a camera shake as an example in the ninth embodiment. However if the embodiment described above employ an optical wedge as described in the fourth embodiment to be driven to rotate, it is possible to compensate for a camera shake in the same way as the above.

Also in the ninth embodiment that compensation for a camera shake is carried out by rotation of the lens frame 512, it is possible to employ the method of controlling the pulse width of the applied voltage which is described in FIG. 11. But, the description which has been already made in FIG. 11 will be omitted.

### Tenth Embodiment

In the previous embodiments, compensation for a camera shake is carried out by driving an optical device such as a compensation lens and an optical wedge. Description of an embodiment in which compensation for a camera shake is carried out by driving an image taking device (more concretely CCD) will be made below.

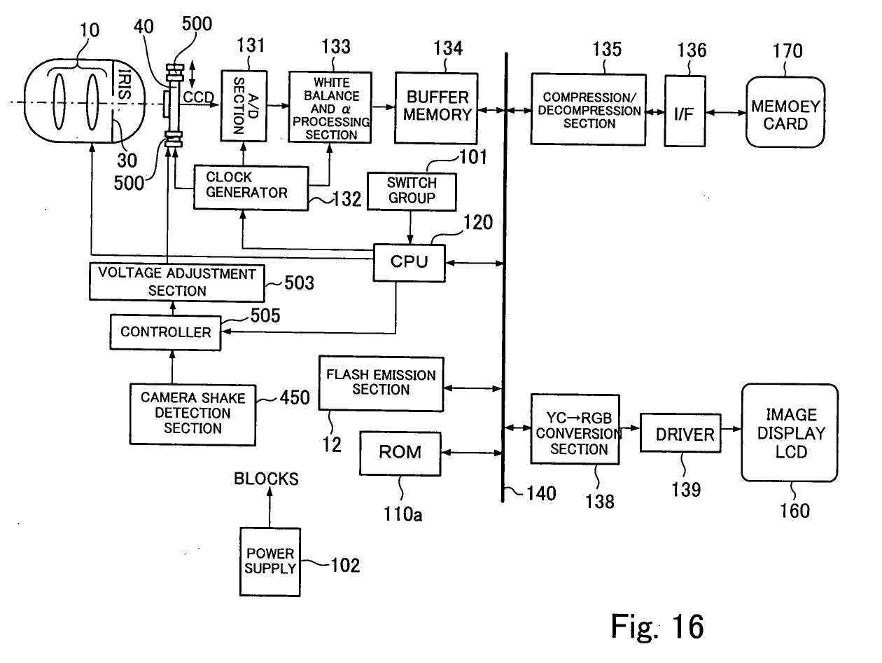

FIG. 16 is a schematic diagram showing an internal configuration of the digital camera in which compensation for a camera shake is carried out by driving a CCD.

In the following description, the same components as those of the internal configuration on FIG. 2 will be denoted by the same reference numerals as the corresponding reference numerals of the internal configuration on FIG. 2. The description of them which has been already made in FIG. 2 will be omitted below.

In the internal configuration of the digital camera in FIG. 16, the polymer actuator 500 is mounted on the CCD 40, instead of the compensation lens 20 shown in FIG. 2, and drives the CCD 40. Except for this point, the internal configuration of the digital camera in FIG. 16 is the same as that of the digital camera in FIG. 2

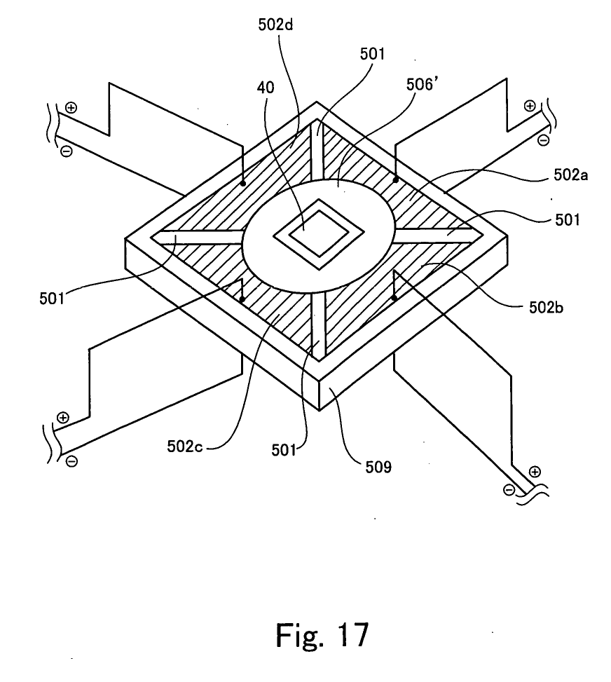

FIG. 17 shows the CCD and a mechanism to drive this CCD.

The mechanism to drive the CCD in FIG. 17 is different from that in FIG. 3 in a point that a holder 506′ holds the CCD 40, instead of the compensation lens 20. Except for this point, a structure and a function of the polymer actuator 500 is the same as those in FIG. 3 and the description of them which has been already made in FIG. 3 will be omitted below. Voltages are supplied to the four pairs of electrodes 502a, 502b, 502c, 502d (only anodes are depicted) of the polymer actuator in FIG. 17 by the structure for application of voltage in FIG. 4. Incidentally, the voltage adjustment section 503 shown in FIG. 16 represents the four voltage adjustment sections 503a, 503b, 503c, 503d in an integrated form for depiction, and there exist four voltage adjustment sections, rather than one voltage adjustment section.

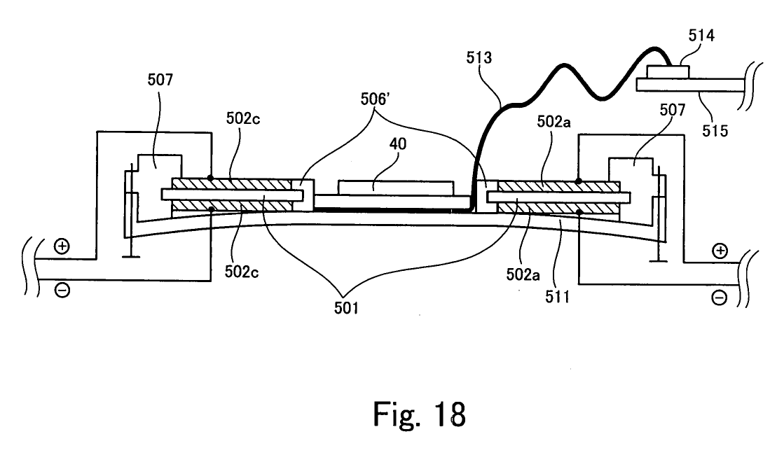

FIG. 18 shows a sectional view of the CCD and the polymer actuator shown in FIG. 17.

The holder 506′ holds the CCD 40, instead of the compensation lens 20 in FIG. 2, and there is mounted a CCD holding plate 511 which holds the CCD 40 from behind. The CCD holding plate 511 is an insulator, which prevents the CCD 40 from being electrically affected by the surroundings. The CCD holding plate 511 has a shape which gently curves upward in FIG. 18, which enables the CCD holding plate 511 without preventing the polymer actuator from expanding. Moreover, there is disposed a flexible board 513 on the surface of the CCD 40 which contacts the CCD holding plate 511. The flexible board 513 is electrically connected with the CCD 40. In addition, the flexible board 513 is also electrically connected with a main board 515 of a digital camera main body via a connector 514. The flexible board 513 is long enough not to hamper drive of the CCD 40 due to its existence. Except for these points, a structure and a mechanism to compensate for a camera shake by driving the CCD 40 when a camera shake occurs in the tenth embodiment are the same as those of the image taking apparatus which is described in FIG. 4 to FIG. 7. Thus, the same description which has been already made above is omitted.

Also in the tenth embodiment that compensation for a camera shake is carried out by driving the CCD, it is possible to employ the method of controlling the pulse width of the applied voltage which is described in FIG. 11. But, the description which has been already made in FIG. 11 will be omitted.

### Eleventh Embodiment

Also in the tenth embodiment that compensation for a camera shake is carried out by driving the CCD, it is possible to employ an external frame whose cross section perpendicular to light incident from a subject is circular, as in the case in FIG. 10 in which compensation for a camera shake is carried out by driving the compensation lens. Description of such an embodiment will be made below as the eleventh embodiment.

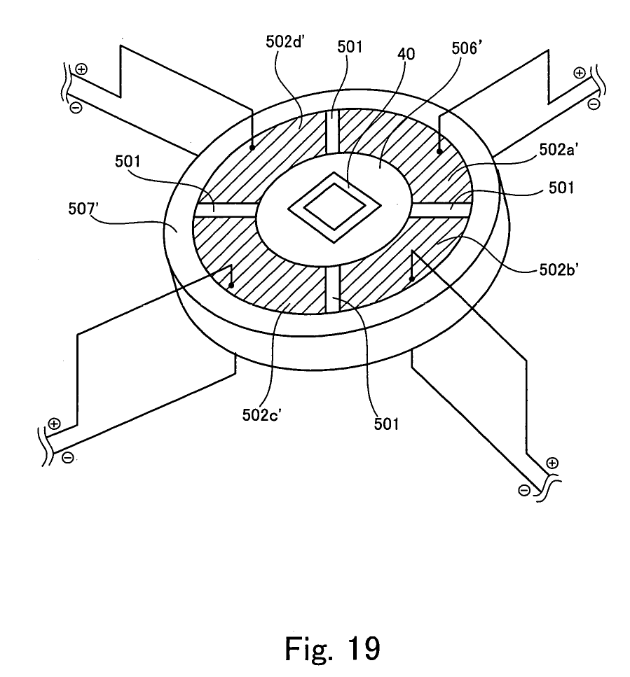

FIG. 19 shows an external frame whose cross section perpendicular to light incident from a subject is circular in the embodiment in which compensation for a camera shake is carried out by driving the CCD.

It is a point that the holder 506′ holds the CCD 40 in FIG. 19 instead of the compensation lens 20 in FIG. 2 that is different from the case in FIG. 10 in which an external frame whose cross section is circular. Except for this point, a structure and a mechanism to compensate for a camera shake by driving the CCD 40 when a camera shake occurs in the tenth embodiment are the same as those of the image taking apparatus in the first embodiment. Thus, the same description which has been already made above is omitted.

### Twelfth Embodiment

In the previous embodiments, a camera shake is compensated by application of a voltage of a value which corresponds to the detected camera shake. It is possible to employ another method in which a camera shake is compensated by release of a voltage of a value which corresponds to the detected camera shake. Description of such an embodiment will be made below as the twelfth embodiment.

An external view and a structure of an image taking apparatus in the twelfth embodiment are the same as those of the image taking apparatus in the first embodiment. Thus, the same description which has been already made above is omitted. In the twelfth embodiment, voltages are applied to the polymer actuator before a camera shake is detected. When a camera shake is detected, an appropriate pair of electrodes which corresponds to the detected camera shake is selected and a voltage supplied to the pair of electrodes is released. The dielectric elastomer which expands before the release of a voltage contracts by this release. The compensation lens is driven by the contraction of the polymer actuator and the camera shake is compensated for.

Incidentally, the compensation lens 20 is driven by release of a voltage as an example in the twelfth embodiment. However the embodiment described above may employ a CCD to be driven as in the tenth embodiment. Such an embodiment is the same as that of the twelfth embodiment except for a point that a driven object is a CCD instead of a compensation lens. Thus, the description which has been already made above will be omitted.

### Thirteenth Embodiment

Next, embodiments of an image taking system and a compensation method of image formation position according to the present invention will be described below.

In the following description, a digital camera is employed as an example of an image taking apparatus in an image taking system according to the present invention. An external view of the digital camera is the same as that of the digital camera in FIG. 1. Thus, the same description which has been already made is omitted.

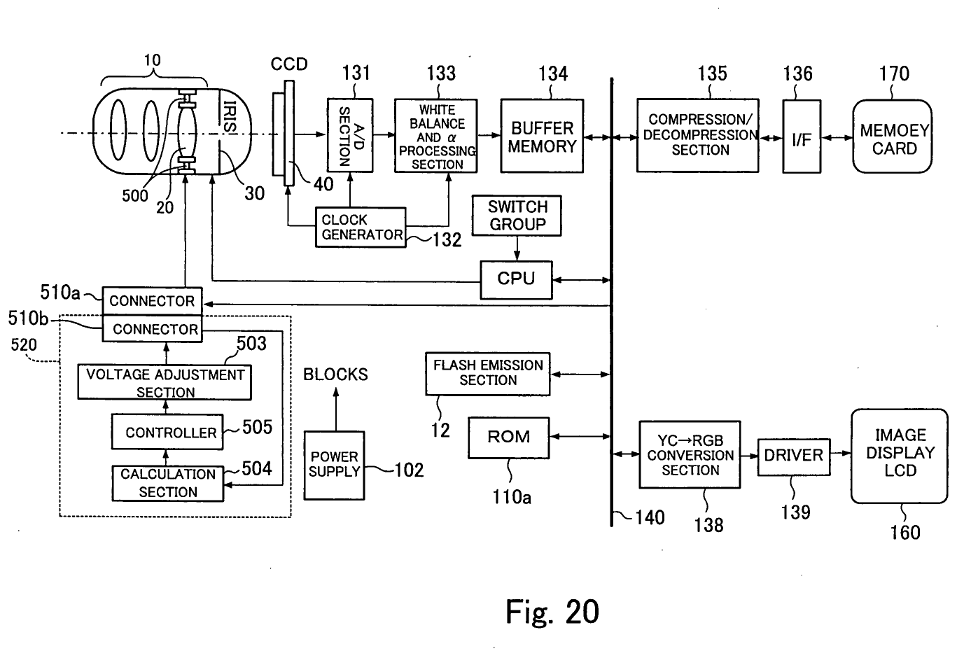

FIG. 20 is a schematic diagram showing an internal configuration of the digital camera in the embodiment of the image taking system and an internal configuration of an eccentricity compensation apparatus which is connected with the digital camera.

It is a point that there is mounted a compensation lens 20 in the rear in the image taking lens 10 and a mechanism to drive the compensation lens 20 by connecting the eccentricity compensation apparatus 520 with the digital camera that the internal configuration of the digital camera in the embodiment is different from that of the digital camera 1 in FIG. 1. Except for this point, the internal configuration of the digital camera in the embodiment is the same as that of the digital camera 1 in FIG. 1. Thus, in the following description, the same components as those of the internal configuration on FIG. 2 will be denoted by the same reference numerals as the corresponding reference numerals of the internal configuration on FIG. 2. The description of them which has been already made in FIG. 2 will be omitted below and the different point is focused.

A so-called eccentricity of a lens sometimes happens by mounting a lens and a CCD in a position displaced relative to each other in a production process of an image taking apparatuses. The image taking lens 10 in the embodiment contains a compensation lens which compensates for the effect of an eccentricity of a lens. Compensation for an eccentricity is carried out by moving the compensation lens 20 on the plane which is perpendicular to the direction along light incident from a subject using a polymer actuator which is mounted near the compensation lens 20. Also, there is mounted a camera side connector 510a in this digital camera which is connected with an apparatus side connector 510b of the eccentricity compensation apparatus 520. Eccentricity compensation operation is carried out by connecting the apparatus side connector 510b with the camera side connector 510a. The eccentricity compensation apparatus 520 has a calculation section 504, a voltage adjustment section 503 and a controller 505. The calculation section 504 calculates the degree of an eccentricity which represents an amount of displacement of image formation position from image data. The voltage adjustment section 503 adjusts a voltage applied to the polymer actuator 500. The controller 505 obtains a necessary voltage to drive the polymer actuator 500 based on calculation of the calculation section 504 and controls the voltage adjustment section 503. The photographic image data stored in the buffer memory 134 is supplied to the calculation section 504 via the apparatus side connector 510b and the camera side connector 510a for calculation of the degree of an eccentricity. The controller 505 carries out compensation of an eccentricity by moving the compensation lens 20 on the plane which is perpendicular to the direction along light incident from a subject. The eccentricity compensation apparatus 520 is an example of the image formation position compensation unit according to the present invention and the camera side connector 510a is an example of the connection section according to the present invention. A mechanism and a structure to drive the compensation lens 20 is the same as those described in FIG. 3 to FIG. 5 and FIG. 7. Thus the same description which has been already made in the previous embodiment will be omitted.

Next, description of a flow of the eccentricity compensation operation by using the above configurations will be made.

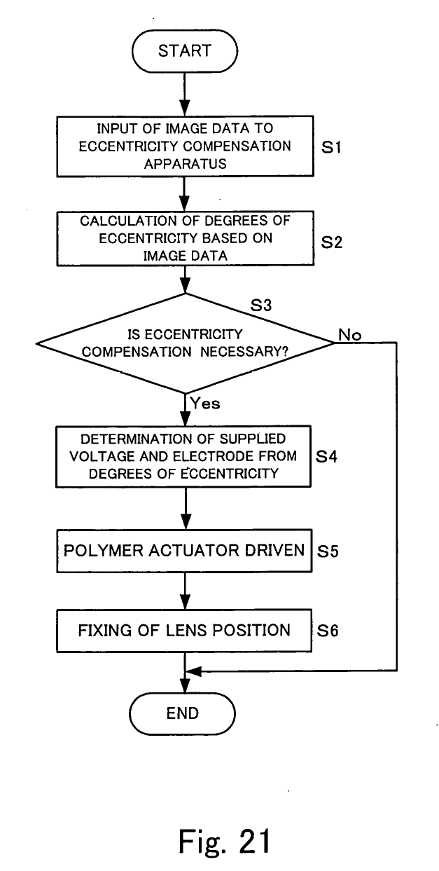

FIG. 21 is a flowchart showing flow of the eccentricity compensation operation.

First, the apparatus side connector 510b of the eccentricity compensation apparatus 520 in FIG. 20 is connected with the camera side connector 510a of the digital camera for a check of an eccentricity. Then a shooting is performed by using the digital camera, such that the a light emission surface whose brightness distribution is almost uniform can be only the subject of the shooting. By the image taking, photographic image data is formed and stored in the buffer memory 134 in FIG. 20 for a while. Then the photographic image data is input into the calculation section 504 in the eccentricity compensation apparatus 520 via the apparatus side connector 510b and the camera side connector 510a (step S1).

In general, an amount of received light decreases as the position where light is received becomes farther from the optical axis on a light-receiving surface of the CCD 40 which receives a light incident from a subject. Therefore, amounts of light received on the edges of the light-receiving surface (for example, four corners of the light-receiving surface) of the CCD 40 is unbalanced in the case that the optical axis of the image taking lens 10 is displaced from the center of the light-receiving surface due to an eccentricity. Making use of this phenomena, a scale of an eccentricity and its direction can be evaluated by analysis of portions of image data which represent a light incident from a subject received on the edges of the light-receiving surface of the CCD 40. The calculation section 504 selects portions of photographic image data from the input photographic image data which are formed based on the light received on the four corners of the light-receiving surface of the CCD 40. Then the calculation section 504 calculates the degree of an eccentricity which represents a scale of an eccentricity and its direction, based on their relative differences of brightness (step S2). More concretely, the degree of an eccentricity represents an amount of displacement of image formation position by x, γ coordinates on the two-dimensional plane (x-y plane) which is perpendicular to the direction along light incident from a subject. If an eccentricity is small, values of x, γ coordinates which represent the eccentricity which are nearly zero. Data of the calculated the degree of an eccentricity is input into the controller 505 and necessity of compensation of the eccentricity is judged, based on whether the calculated degree of the eccentricity (length in the x-y plane) is more than a predetermined value or not (step S3).

As described above, the calculation section 504 in the eccentricity compensation apparatus 520 calculates the degree of an eccentricity based on photographic image data stored in the buffer memory 134 in the embodiment. However, the present invention is not limited to this form and the embodiment described above may employ another form in which an image data processing section such as white balance compensation and γ compensation by a white balance and γ processing section 133 plays a role of the above calculation section 504 to calculate the degree of an eccentricity and the calculated the degree of an eccentricity is input into the controller 505 in the eccentricity compensation apparatus 520. Also, the embodiment described above may employ a calculation section which calculates the degree of an eccentricity based on photographic image data which is immediately after being converted from an analog signal into a digital signal and before being stored in the buffer memory 134, instead of photographic image data stored in the buffer memory 134. Also, the embodiment described above may employ a calculation section which calculates the degree of an eccentricity based on photographic image data after compression process or live view data instead of photographic image data.

In the case that it is judged that it is not necessary to compensate for an eccentricity (step S3; No), the check of an eccentricity of a lens of the digital camera is completed. In the case that it is judged that it is necessary to compensate for an eccentricity (step S3; Yes), determinations of which pair of electrodes of the four pairs of electrodes of the polymer actuators 500 in FIG. 3 and FIG. 4 a voltage should be supplied with a voltage and the value of the supplied voltage is made (step S4). Then, based on an instruction of the controller 505, the voltage adjustment sections 503 in FIG. 20 supplies a voltage of the determined value to the determined pair of electrodes in the step S4 and the polymer actuator 500 is driven (step S5). A combination of the controller 505 and the four voltage adjustment sections 503a, 503b, 503c, 503d is an example of the displacement compensation section according to the present invention. Compensation for an eccentricity is carried out by moving the compensation lens 20 and holder 506 on the plane which is perpendicular to the direction along light incident from a subject using application of a voltage to the polymer actuator 500. The movement of the compensation lens 20 and holder 506 is the same as that of the compensation lens 20 and holder 506 in FIG. 6. Thus, the same description which has been already made will be omitted.

It is necessary to fix the compensation lens 20 on the position where compensation for an eccentricity is carried out in order to keep the compensation lens 20 at this position after stopping application of a voltage to the polymer actuator 500. For this purpose, there is mounted a fixing section which fixes the compensation lens 20 on the position. After the compensation lens 20 is moved to the position to compensate for an eccentricity, an operation of fixing the compensation lens 20 on the position by using the fixing section (step S6) is performed.

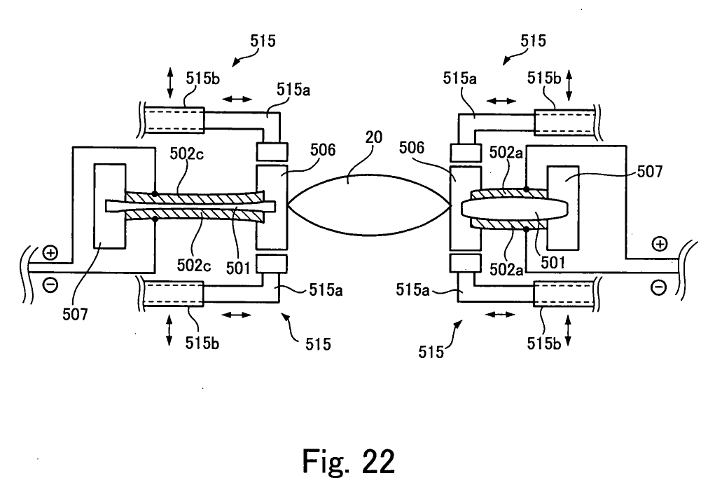

FIG. 22 shows a mechanism to fix the compensation lens.

In FIG. 22, there are shown four fixing sections 515 which sandwich the holder 506 between both its upper side and lower side. These four fixing sections 515 are the ones which fix the holder 506 with respect to the horizontal direction in FIG. 22. There are additional four fixing sections 515 (not shown) which fix the holder 506 with respect to the direction perpendicular to FIG. 22 and they have the same a structure as that of the four fixing sections 515 in FIG. 22. The fixing sections 515 in FIG. 22 includes an arm 515a which expands and contracts in the direction along the compensation lens 20 (horizontal direction in FIG. 22) and an arm accommodation section 515b which accommodates the arm 515a according to contraction and expansion of the arm 515a. These fixing sections 515 can move upward and downward in FIG. 22. In the fixing operation of the holder 506, the holder 506 is fixed by being sandwiched between the turning end portions of the arms 515a of the fixing sections 515 on the upper side of the holder 506 and those of the fixing sections 515 on the lower side of the holder 506. The horizontal position of the compensation lens 20 can be moved to any required position for compensation for an eccentricity because the position of the holder 506 can be flexibly changed owing to contraction and expansion of the arm 515a in the horizontal direction.

After completion of the fixing, application of a voltage is stopped. Hereafter, the polymer actuator is not necessary any more as an actuator, but useful as a damper due to its elasticity like rubber against impact on the digital camera from outside when the image taking system is used. As a result, the polymer actuator produces an effect to reduce the damage of the compensation lens originated from the impact.

The description of the thirteenth embodiment of the present invention is completed above.

As described above, an eccentricity of this digital camera is compensated by driving the compensation lens 20 with the mechanism which is simpler than that of a conventional small camera. Moreover, the polymer actuator is so cheap that it is possible to realize cost reduction for a mechanism to compensate for an eccentricity.

In the thirteenth embodiment, the object in which an eccentricity is compensated for is a digital camera. However, the present invention is not limited to this, the embodiment described above may employ a photographic unit such as a photographic unit mounted with a portable phone as the object in which an eccentricity is compensated. In this case, it is possible to use a USB terminal mounted on the photographic unit as a substitute for the camera side connector 510a for compensation for an eccentricity shown in FIG. 20.

### Fourteenth Embodiment

In the thirteenth embodiment, the compensation lens 20 is connected with the polymer actuator 500 via the holder 506. However, the present invention is not limited to this method and the embodiment described above may employ another method in which a transparent dielectric elastomer that light easily runs through is used to connect the compensation lens 20 directly with the polymer actuator 500 without using the holder 506. Except this point, an external view, a structure and a mechanism to compensate for an eccentricity of an image taking apparatus in such an embodiment are the same as those of the image taking apparatus in the thirteenth embodiment. Thus, the same description which has been already made will be omitted. In the thirteenth embodiment the compensation lens 20 is fixed on the position to compensate for an eccentricity by fixing the both ends of the compensation lens 20. But it is possible to employ another fixing method in which UV solidifying material which is solidified under ultraviolet rays radiation is used. In this fixing method, the UV solidifying material is mixed with the dielectric elastomer 501′ in FIG. 6. After the compensation lens 20 is moved to the position to compensate for an eccentricity, the UV solidifying material is solidified under ultraviolet rays radiation and the compensation lens 20 is fixed on the position.

### Fifteenth Embodiment

In the thirteenth and fourteenth embodiments, the compensation lens 20 is a single lens. However, the present invention is not limited to this type and the embodiment described above may employ a combination lens to compensate for an eccentricity as described in FIG. 9. Except this point, an external view, a structure and a mechanism to compensate for an eccentricity of an image taking apparatus in such an embodiment are the same as those of the image taking apparatus in the thirteenth and fourteenth embodiments. Thus, the same description which has been already made will be omitted.

### Sixteenth Embodiment

In the thirteenth to fifteenth embodiments described above, the external frame 507 to fix the polymer actuator has a square cross section with respect to the plane which is perpendicular to the direction along light incident from a subject. However, the present invention is not limited to this shape and the embodiments described above may employ an external frame whose cross section is circular as described in FIG. 10. Except this point, an external view, a structure and a mechanism to compensate for an eccentricity of an image taking apparatus in such an embodiment are the same as those of the image taking apparatus in the thirteenth embodiment. Thus, the same description which has been already made will be omitted.

### Seventeenth Embodiment

In the thirteenth to sixteenth embodiments described above, the voltages to be supplied to the four pairs of electrodes is adjusted via adjustment of the values of the voltages. However, the present invention is not limited to this adjustment method and the embodiments described above may employ another adjustment method as described in FIG. 11, for example, a so-called PWM control method in which adjustment of time intervals when a voltage is applied is carried out in order to control drive of a mobile optical device for compensation for an eccentricity, although voltage application has only two stages of On and Off. Except this point, an external view, a structure and a mechanism to compensate for an eccentricity of an image taking apparatus in such an embodiment are the same as those of the image taking apparatus in the thirteenth embodiment. Thus, the same description which has been already made will be omitted.

### Eighteenth Embodiment

In the thirteenth to seventeenth embodiments, an eccentricity is compensated by application of a voltage of a value which corresponds to the eccentricity. It is possible to employ another method in which an eccentricity is compensated for by release of a voltage of a value which corresponds to the eccentricity. Description of such an embodiment will be made below as the twelfth embodiment.

An external view and a structure of an image taking apparatus in the eighteenth embodiment are the same as those of the image taking apparatus in the thirteenth embodiment. Thus, the same description which has been already made above is omitted. In the eighteenth embodiment, voltages are applied to the polymer actuator before an eccentricity is compensated for. When necessity of compensation of an eccentricity is recognized, an appropriate pair of electrodes which corresponds to the degree of the eccentricity is selected and a voltage supplied to the pair of electrodes is released. The dielectric elastomer which expands before the release of a voltage contracts by this release. The compensation lens is driven by the contraction of the polymer actuator and the eccentricity is compensated for.

### Nineteenth Embodiment

Next, embodiments of the fifth camera shake compensation unit and the fifth image taking apparatus according to the present invention will be described below.

In the following description, a digital camera is employed as an example of the fifth image taking apparatus according to the present invention. An external view of the digital camera is the same as that of the digital camera in FIG. 1. Thus, the same description which has been already made is omitted. Except for a point that the nineteenth embodiment employs a polymer actuator and a voltage adjustment section which has different a structure from that of the polymer actuator 500 and the voltage adjustment section 503 in FIG. 16, an internal configuration of this digital camera is the same as that of the digital camera 1 in FIG. 16. Thus, the same description which has been already made is omitted. In this digital camera, when a camera shake is detected, compensation for a camera shake is carried out by rotating and moving the CCD 40 on the plane which intersects with the direction along light incident from a subject. A mechanism of this digital camera to compensate for a camera shake will be described below.

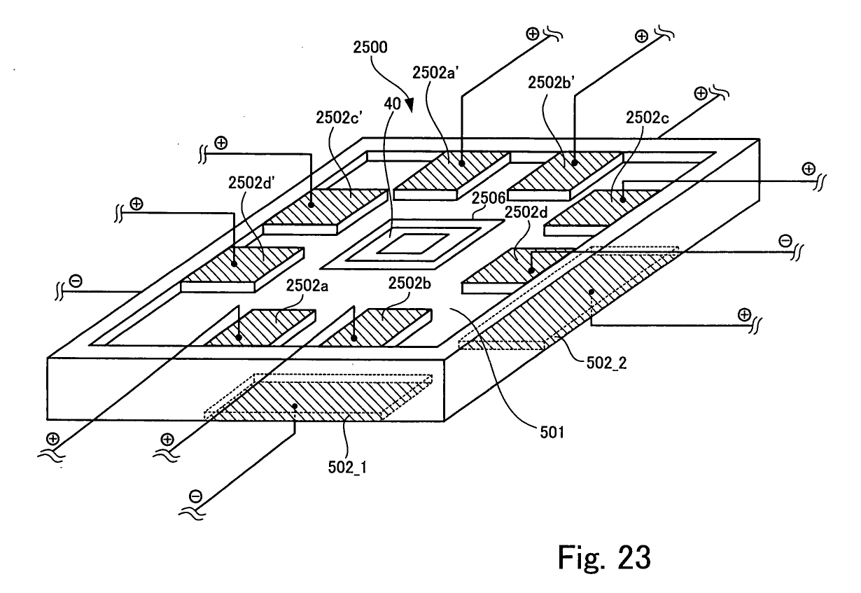

FIG. 23 shows the CCD and a mechanism to move this CCD.

The digital camera has the polymer actuator 2500 to move the CCD 40. The polymer actuator 2500 has a shape of a square with a square hole on its center by which a square holder 2506 is surrounded. Also, around the polymer actuator 2500, an external frame 2507 which fixes the external ends of the polymer actuator 2500. A combination of the CCD 40 and the holder 2506 is an example of the image taking device according to the present invention, and the external frame 2507 is an example of the holding member.

The polymer actuator 2500 includes eight electrodes 2502a, 2502b, 2502c, 2502d, 2502a′, 2502b′, 2502c′, 2502d′ on the upper side and four electrodes (only two electrodes 502_1, 502_2 are shown) on the lower side in addition to the same dielectric elastomer 501 as that of the first embodiment. Each of electrodes 2502a, 2502b, 2502c, 2502d, 2502a′, 2502b′, 2502c′, 2502d′ on the upper side and of four electrodes on the lower side is made of carbon fiber with high conductivity and is put on the dielectric elastomer 501. The eight electrodes 2502a, 2502b, 2502c, 2502d, 2502a′, 2502b′, 2502c′, 2502d′ on the upper side are anodes and the four electrodes on the lower side are cathodes. Two of the eight anodes on the upper side are positioned opposite to each of the four cathodes on the lower side with the dielectric elastomer 501 between them. That is, they constitute four pairs of electrodes in which two anodes on the upper side and a cathode on the lower side consist in one pair. These four pairs of electrodes are respectively connected with an anode and a cathode of the power which is not shown in FIG. 23, constituting four closed electric circuits. For example, the two electrodes 2502a, 2502b on this side and the electrodes 502_1 below them constitute one pair in FIG. 23. The pair is connected with the power which is not shown in this figure and constitute a closed a closed electric circuit. The polymer actuator 2500 has the four closed electric circuits such as this circuit corresponding to the four pairs of electrodes.

The dielectric elastomer 501 has a shape of a square with a square hole on its center by which the square holder 2506 is surrounded. A part of the dielectric elastomer 501 which is not covered with the eight electrodes 2502a, 2502b, 2502c, 2502d, 2502a′, 2502b′, 2502c′, 2502d′ appears in FIG. 23.

The above structure of the polymer actuator 2500 makes it possible to apply voltages of different values to the eight parts of the dielectric elastomer 501 sandwiched between the eight electrodes on the upper side and the four electrodes on the lower side. Then a mechanism to apply voltages with different values to the eight parts will be described below. Description of a part of the dielectric elastomer 501 sandwiched between the upper electrodes 2502a, 2502b on this side and the lower electrode 502_1 below them will be described below as an example.

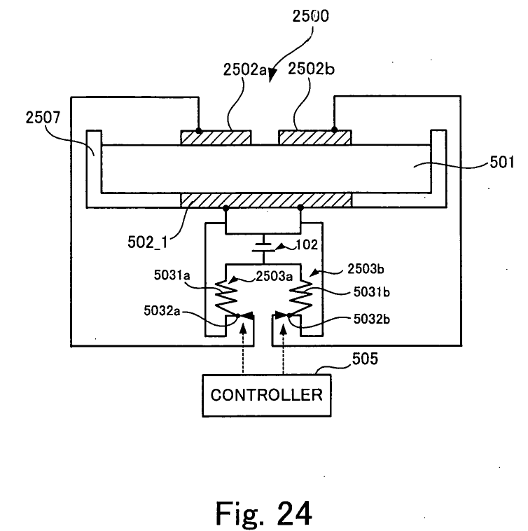

FIG. 24 is a sectional view of the polymer actuator which shows a mechanism to apply a voltage to a part of the dielectric elastomer sandwiched between two anodes on the upper side and a cathode on the lower side.

As shown in FIG. 24, the two electrodes 2502a, 2502b on the upper side of the polymer actuator 2500 are connected with anodes of the power 102 via voltage adjustment sections 2503a, 2503b. Such a voltage adjustment section as these voltage adjustment sections 2503a, 2503b is mounted for each anode electrode of the polymer actuator 2500. That is, there are eight voltage adjustment sections in the digital camera. The two voltage adjustment sections 2503a, 2503b have resistors 5031a, 5031b respectively and there are mobile terminals 5032a, 5032b on the resistors 5031a, 5031b, respectively. These mobile terminals 5032a, 5032b can change its position on the resistors 5031a, 5031b. The above mentioned two electrodes 2502a, 2502b on the upper side are connected with the mobile terminals 5032a, 5032b, respectively. On the other hand, the electrode 502_1 on the lower side is connected with the cathode of the power 102. Also, the power is connected with the two resistors 5031a, 5031b in parallel, which constitutes two electric circuits, respectively. Current flows through the two electric circuits, which leads to a potential difference between two ends of each of the resistors 5031a, 5031b whose value is the same as that of the supply voltage of the power 102. Potential differences between the electrode 502_1 on the lower side and the electrodes 2502a, 2052b on the upper side change according to the positions of the mobile terminals 5032a, 5032b on the two resistors 5031a, 5031b, respectively. FIG. 24 shows a state in which the mobile terminals 5032a, 5032b are at the lowest position in this figure on the two resistors 5031a, 5031b. In this state, a potential of the electrode 502_1 on the lower side is the same as those of the electrodes 2502a, 2052b on the upper side, which means there is no voltage applied to the part of the dielectric elastomer 501 sandwiched between the electrodes 2502a, 2502b on the upper side and the lower electrode 502_1 on the lower side. The controller 505 has a role of controlling the positions of the mobile terminals 5032a, 5032b and a value of a voltage applied to the dielectric elastomer 501 is determined according to a camera shake detected by the camera shake detection section in FIG. 2.

Incidentally, voltages are supplied by the power 102 in the embodiment. However, it may be possible to use high voltage supplied to the flash emission section 12.

Next, description of a state in which a voltage is applied to the dielectric elastomer 501 will be made below. In the following description, the case in which a voltage is applied to a part of the dielectric elastomer 501 sandwiched between the left electrodes 2502a of the two electrodes 2502a, 2502b on the upper side and the electrode 502_1 on the lower side will described as an example.

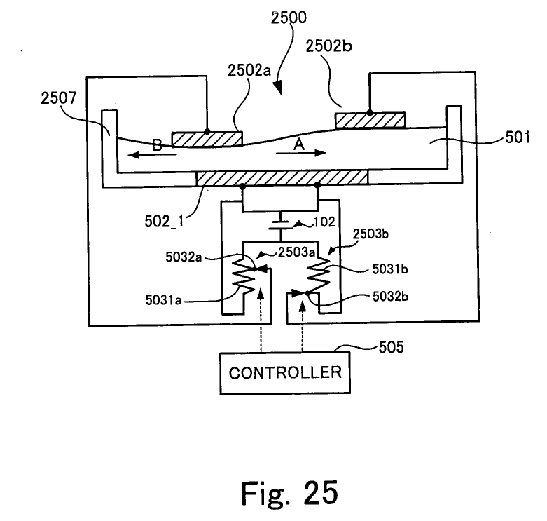

FIG. 25 is a sectional view of the polymer actuator 2500 which shows a state in which a voltage is applied to a part of the dielectric elastomer in the FIG. 24 which is sandwiched between the left electrodes of the two electrodes on the upper side and the electrode on the lower side.

When the mobile terminals 5032a is moved to a upper position than that of the mobile terminals 5032a in FIG. 24, that is, a potential difference is generated between the left electrodes 2502a and the electrode 502_1 on the lower side, a part of the dielectric elastomer 501 sandwiched between these electrodes expands, as shown in FIG. 25, in the direction of an arrow A and an arrow B in this figure. In the same way, the part of the dielectric elastomer 501 expands in the direction perpendicular to FIG. 25, although its depiction is omitted.

The same mechanism as the above is mounted for each of the four pairs of electrodes described in FIG. 23 and voltages are applied to parts of the dielectric elastomer 501 between the anodes and cathodes.

Description of how to compensate for a camera shake which causes a shift and rotation of a subject image will be described. For compensation of such a camera shake, the mechanism described above is used in order to rotate and shift the CCD 40 on the plane which is perpendicular to the direction along light incident from a subject.

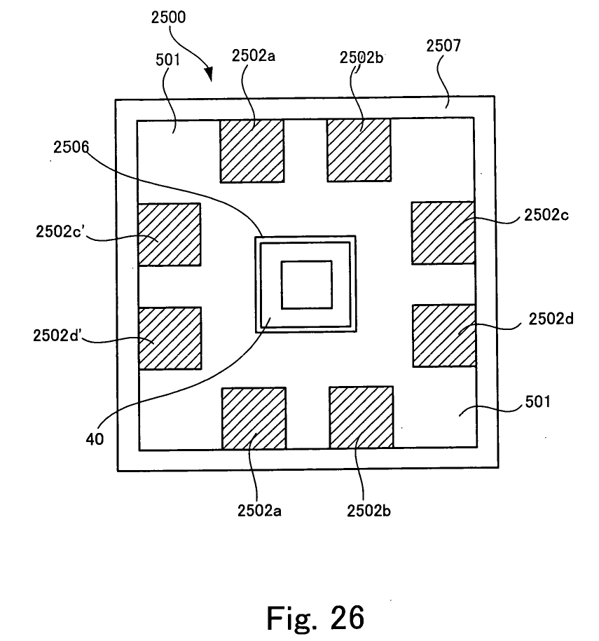

FIG. 26 is an external perspective view of the polymer actuator and the CCD with respect to the direction in which light incident from a subject comes in a state that a voltage is not applied.

When no voltages are applied between the eight anode electrodes 2502a, 2502b, 2502c, 2502d, 2502a′, 2502b′, 2502c′, 2502d′ and four cathode electrodes (not shown), the state shown in FIG. 26, in which the holder 2506 is positioned in such a manner that the frame of the holder 2506 is parallel with end sides of the external frame 2507 respectively, is realized as the most stable state.

When a camera shake occurs and the camera shake detection section 450 in FIG. 16 detects the camera shake, the controller 505 calculates a rotational angle and its rotational direction that the CCD 40 should rotate, and the distance and its direction that the CCD 40 should be shifted in order to compensate for the camera shake. Moreover, the controller 505 determines which electrode a voltage should be supplied to and the value of the supplied voltage. Then the controller 505 controls a voltage adjustment section connected with the determined electrode. Then a voltage of the determined value is supplied to the polymer actuator 2500. A combination of the controller 505 and the eight voltage adjustment sections mounted in the four closed electric circuits two by two is an example of the camera shake compensation section according to the present invention.

Description of how the CCD 40 is driven will be made in detail below. In the following description, compensation for a camera shake which causes rotation of a subject image, not a shift of a subject image will be described first. Then compensation for a camera shake which causes both rotation and a shift of a subject image will be described.

First, compensation for a camera shake which causes rotation of a subject image will be described.

Description will be made below, as an example, on the supposition that it is required that the CCD 40 is rotated clockwise in the direction of light incident from a subject from its position shown in FIG. 26 so as to compensate for a camera shake. In order to realize the rotation of the CCD 40, the controller 505 determines to supply a voltage to the anode electrode 2502a on the left-lower position of the CCD 40 and the cathode electrode 502_1 in FIG. 25 (not shown in FIG. 26) which sandwiches the dielectric elastomer 501 along with the anode electrode 2502a. Moreover, In order to avoid a shift of the CCD 40, the controller 505 also determines to supply a voltage of the same value as the above mentioned voltage to the anode electrode 2502b′ on the right-upper position of the CCD 40 and the cathode electrode (not shown in FIG. 26) which sandwiches the dielectric elastomer 501 along with the anode electrode 2502b′.

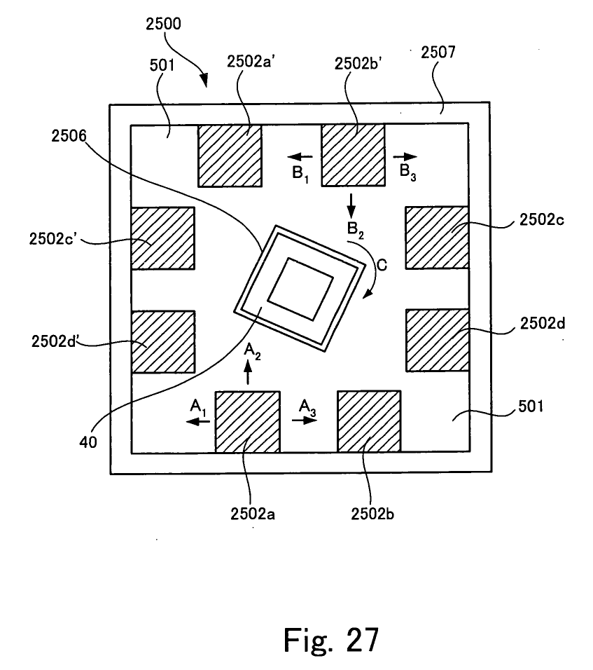

FIG. 27 shows a state of the polymer actuator and the CCD when voltages are applied to two parts of the dielectric elastomer by using the electrodes which are on the left-lower position and on the right-upper position of the CCD.

A part of the dielectric elastomer 501 near the electrode 2502a which are on the left-lower position of the CCD 40 expands in the direction of arrows A1, A2, A3 in FIG. 27 because the dielectric elastomer 501 has a property to expand along an electrode which applies a voltage to the dielectric elastomer 501, as described in FIG. 25. In the same way, another part of the dielectric elastomer 501 near the electrode 2502b′ which are on the right-upper position of the CCD 40 expands in the direction of arrows B1, B2, B3 in FIG. 27. Among expansion force in three directions represented by the arrows A1, A2, A3, B1, B2, B3, only the expansion force represented by the upward arrows A2 and the downward arrow B2 gives effect to move the CCD 40. The magnitude of the two kinds of force are the same because the value of the voltage supplied to the electrodes 2502a which are on the left-lower position of the CCD 40 is the same as that of the electrode 2502b′ which is on the right-upper position of the CCD 40. As a result, the two kinds of force generates torque to rotate the CCD 40 counterclockwise without moving the center of the CCD 40. The CCD is rotated by the torque and the camera shake which causes rotation of a subject image is compensated.

The description of compensation of a camera shake which causes rotation of a subject image is completed above.

Next, description of compensation of a camera shake which causes both rotation and a shift of a subject image will be made. Such a camera shake can be compensated for by rotating and shifting the CCD 40 on the plane which is perpendicular to the direction along light incident from a subject. In the following description, the case in which the CCD 40 is rotated clockwise in the direction of light incident from a subject and shifted upward by using the electrode 2502a on the left-lower position of the CCD 40 and the electrode 2502b′ on the right-upper position of the CCD 40 as described above will be described as an example.

In order to realize a shift of the CCD 40, it is necessary for generating the two kinds of expansion force to act on the CCD 40 that the upward expansion force is larger than the downward expansion force. Therefore, the applied voltages are controlled in order that the voltage supplied to the electrode 2502a on the left-lower position of the CCD 40 is larger than the voltage supplied to the electrode 2502b′ on the right-upper position of the CCD 40.

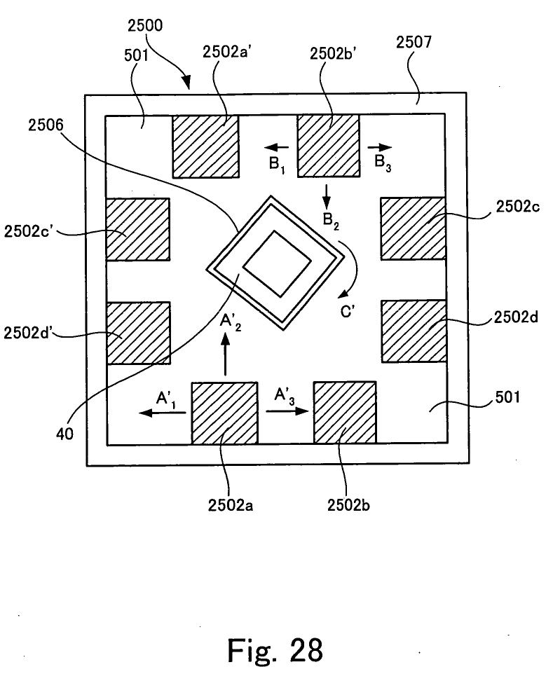

FIG. 28 shows a state of the polymer actuator and the CCD when the voltage supplied to the electrode on the left-lower position of the CCD is larger than the voltage supplied to the electrode on the right-upper position of the CCD.

The part of the dielectric elastomer 501 near the electrode 2502a which are on the left-lower position of the CCD 40 expands in the direction of arrows A1′, A2′, A3′ in FIG. 28 and another part of the dielectric elastomer 501 near the electrode 2502b′ which are on the right-upper position of the CCD 40 expands in the direction of arrows B1, B2, B3 in FIG. 28. The upward expansion force in the direction of the arrow A2′ is larger than the downward expansion force in the direction of the arrow B2 because the voltage supplied to the electrode 2502a on the left-lower position of the CCD 40 is larger than the voltage supplied to the electrode 2502b′ on the right-upper position of the CCD 40. The center of the CCD 40 is shifted upward due to the difference between the two kinds expansion force. In addition to that, the CCD 40 rotates in the direction of an arrow C′ due to torque generated by the two kinds of force. As a result, a camera shake which causes both rotation and a shift of a subject image is compensated for by the rotation and the shift of the CCD 40 described above.

The description of compensation of a camera shake which causes both rotation and a shift of a subject image is completed above.

In the above description, a camera shake which causes at least rotation of a subject image is described. However, a camera shake which causes only a shift of a subject image is also compensated for by shifting the CCD 40 without rotating using the above structure. The shift of the CCD 40 is realized by supplying voltages of the same value to two anode electrodes which belong to the same pair of electrodes. For example, the CCD 40 is shifted upward without rotating by supplying voltages of the same value to the left electrode 2502a and the right electrode 2502b of the two electrodes on this side of FIG. 23.

The description of the nineteenth embodiment is completed above.

As described above, a camera shake of the digital camera is compensated by driving the CCD 40 with the mechanism which is simpler than a conventional mechanism. Moreover, the polymer actuator to drive the CCD 40 is so cheap that the mechanism is appropriate to realize reduction in size and cost of a digital camera.

### Twentieth Embodiment

Compensation of a camera shake which causes both rotation and a shift of a subject image is carried out in the nineteenth embodiment. However, a mechanism which can compensate for only a camera shake which causes rotation of a subject image is useful enough when image taking is carried out in a situation that a camera shake mainly causes rotation of a subject image, not a shift of a subject image. Description of such an embodiment will be made below as the twentieth embodiment. In the twentieth embodiment, a different type of closed electric circuit from that in FIG. 24 is used. Except for this point, an external view of an image taking apparatus and a mechanism to compensate for a camera shake which causes rotation of a subject image in the twentieth embodiment are the same as those of the nineteenth embodiment. Thus, the same description which has been already made above is omitted below and the different point is focused.

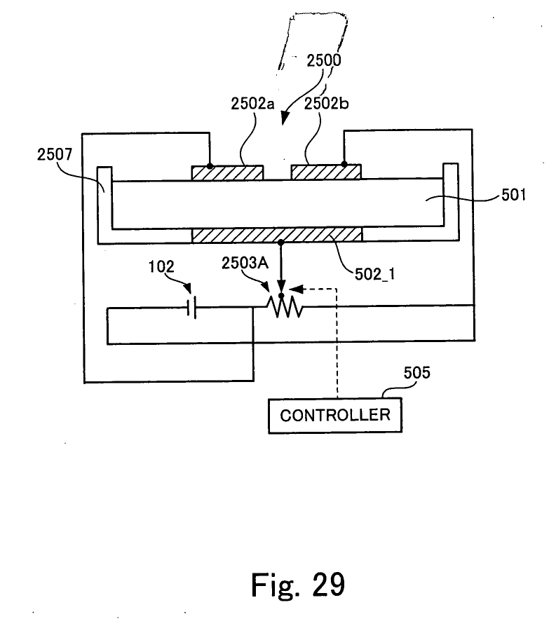

FIG. 29 is a sectional view of the polymer actuator which shows a mechanism to apply a voltage in the embodiment in which only a camera shake which causes rotation of a subject image is compensated.

In the twentieth embodiment, there is mounted only one voltage adjustment section 2503A which corresponds to a closed electric circuit which has the two electrodes 2502a, 2502b on the upper side and the electrode 502_1 on the lower side of the polymer actuator 2500. By this structure, there is a relative difference between two voltages to control, that is, a voltage applied between the left anode electrodes 2502a and the cathode electrode 502_1, and a voltage applied between the right anode electrodes 2502b and the cathode electrode 502_1. The sum of the two voltages is always constant (the same as the supply voltage of the power 102).

There is such a structure for each of the four pairs of electrodes described in FIG. 23, in which two anodes on the upper side and a cathode on the lower side consist in one pair. The sum of the two kinds of voltages is the same (supply voltage of the power 102) in each of the four pairs. Therefore, the four kinds of expansion force generated by the four pairs cancels one another and do not shift the center of the CCD 40. However it is possible to rotate the CCD 40 by controlling the relative difference between the two kinds of voltage applied in a pair of electrodes. For example, this can be achieved by, using two pairs of electrodes, making each of voltages applied by two anode electrodes in the two pairs, which are positioned diagonally opposite to each other with the CCD 40 between them, higher than a voltage applied by the other anode electrodes in each pair. More concretely, for example, the electrodes 2502a which are on the left-lower position of the CCD 40 and the electrode 2502b′ which is on the right-upper position of the CCD 40 in FIG. 27 can be such two anode electrodes positioned diagonally opposite to each other with the CCD 40 between them. By the above mentioned mechanism to apply voltages, the camera shake which causes rotation of a subject image is compensated for in the same way as the mechanism described in FIG. 27 and FIG. 28.

### Twenty-First Embodiment

In the nineteenth embodiment described above, the voltages to drive the polymer actuator is adjusted via adjustment of the values of the voltages. However, the present invention is not limited to this adjustment method and the embodiments described above may employ another adjustment method, for example, a so-called PWM control method in which adjustment of time intervals when a voltage is applied is carried out in order to control drive of the CCD although voltage application has only two stages of On and Off. Description of such an embodiment will be made below as the twenty-first embodiment.

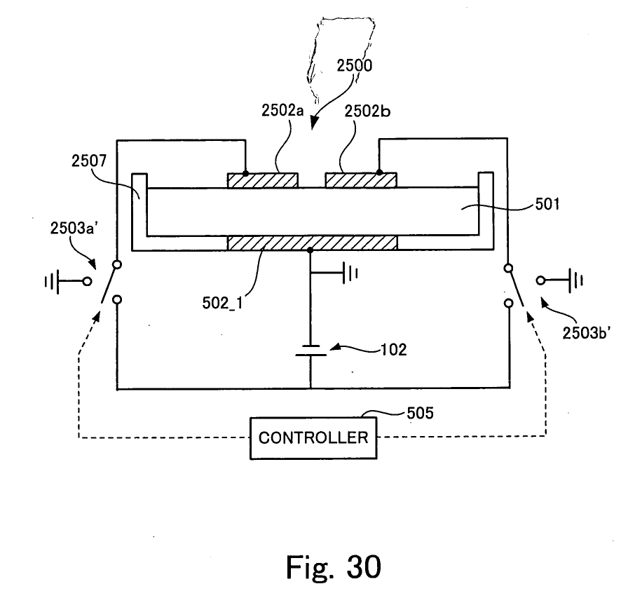

FIG. 30 shows a mechanism to apply voltages of two stages of On and Off to the four pairs of electrodes.

As shown in FIG. 30, in the twenty-first embodiment, there are mounted two switches 2503a′, 2503b′ which switch between the anode of the power supply 102 and the ground (its potential is zero). These two switches determines which the power 102 or the ground in FIG. 30 is electrically connected, by which turning on and off of voltage application between the left anode electrode 2502a and the cathode electrode 502_1, and between the right anode electrode 2502b and the cathode electrode 502_1, respectively. The switching is controlled by the controller 505. Although there are only two kinds of value for an applied voltage such as zero and the value of the supply voltage, the controller 505 can generate a periodic series of square-wave pulses of voltage by switching the two kinds of value for an applied voltage by controlling the switches. The period of the voltage generated by the controller 505 is so short compared with the response time of the dielectric elastomer 501, that the dielectric elastomer 501 feels effectively a constant voltage below the supply voltage which is obtained from an applied voltage averaged by the response time. The pulse width of the applied voltage (time intervals when a voltage is applied) determines the value of the effective voltage. As a result, the controller 505 can control the effective voltage by controlling the pulse width of the applied voltage which consists of a series of square-wave pulse voltages.

Incidentally, the method of controlling the pulse width of the applied voltage which consists of a series of square-wave pulse voltages is employed in order to control the effective voltage in the twenty-first embodiment. However, the present invention is not limited to this method and the embodiment described above may employ another method in which voltage is controlled by controlling a period of an applied voltage which consists of a series of square-wave pulse voltages.

Turning on and off of voltage application to the polymer actuator is carried out by the two switches which is mounted in each of the four pairs of electrodes in the twenty-first embodiment. However, the present invention is not limited to this and the embodiment may employ a circuit element such as a thyristor and a MOS-type FES which turns on and off the electric current in order to control turning on and off of a voltage applied to the polymer actuator 2500.

Incidentally, voltages are supplied by the power 102 in the twenty-first embodiment. However, it may be possible to use high voltage supplied to the flash emission section 12.

Except a point that the CCD is driven under the control of the pulse width of a series of square-wave pulse voltages generated by the voltage application of two stages of On and Off, an external view, a structure and a mechanism to compensate for a camera shake of an image taking apparatus in the twenty-first embodiment are the same as those of the image taking apparatus in the nineteenth embodiment. Thus, the same description which has been already made above is omitted.

### Twenty-Second Embodiment

In the nineteenth to twenty-first embodiments described above, the external frame 2507 to fix the polymer actuator has a square cross section with respect to the plane which is perpendicular to the direction along light incident from a subject. However, the present invention is not limited to this shape and the embodiments described above may employ an external frame whose cross section is circular. Description of such an embodiment will be made below as the Twenty-second embodiment.

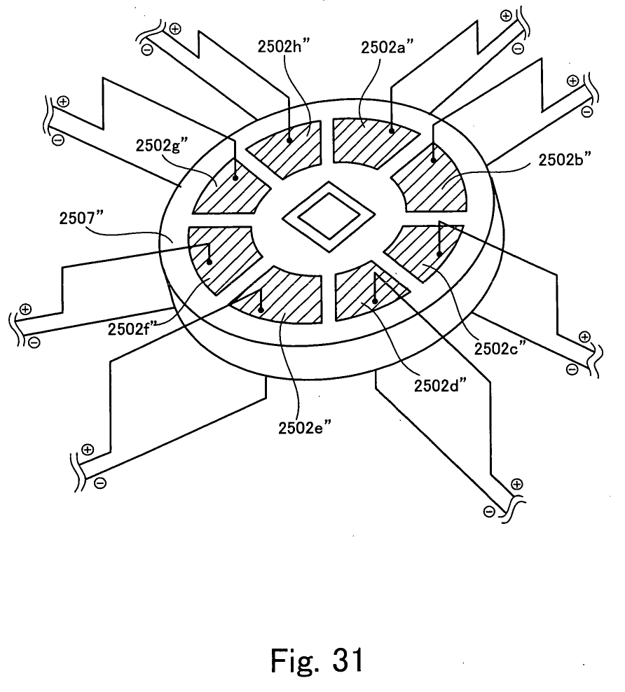

FIG. 31 shows the polymer actuator and the CCD which are fixed by an external frame whose cross section is circular.

Four pairs of electrodes in which two anodes and a cathode consist in one pair are mounted in the twenty-second embodiment in the same way as the case shown in FIG. 23 in which the external frame whose cross section is circular is used. Also, applications of voltages to the dielectric elastomer 501 between these pairs of electrodes is carried out in the same way as the case shown in FIG. 23. FIG. 31 shows eight anode electrodes 2502a″, 2502b″, 2502c″, 2502d″, 2502e″, 2502f″, 2502g″, 2502h″. Among these eight anode electrodes, the two electrodes 2502a″, 2502b″ on the right-far side in FIG. 31 belong to a pair. In the same way, Each two electrodes of the right two electrodes 2502c″, 2502d″ on this side, the left two electrodes 2502e″, 2502f″ on this side, and the left two electrodes 2502e″, 2502f″ on the far side belong to a pair, respectively. Except a point that the shape of the external frame 2507′ is different, an external view, a structure and a mechanism to compensate for a camera shake of an image taking apparatus in the twenty-second embodiment are the same as those of the image taking apparatus in the nineteenth embodiment. Thus, the same description which has been already made in the nineteenth embodiment is omitted.

### Twenty-Third Embodiment

In the nineteenth embodiment, a camera shake is compensated for by application of a voltage of a value which corresponds to the detected camera shake. It is possible to employ another method in which a camera shake is compensated for by release of a voltage of a value which corresponds to the detected camera shake. Description of such an embodiment will be made below as the twenty-third embodiment.

An external view and a structure of an image taking apparatus in the twenty-third embodiment are the same as those of the image taking apparatus in the nineteenth embodiment. Thus, the same description which has been already made above is omitted. In the twenty-third embodiment, voltages are applied to the polymer actuator before a camera shake is detected. When a camera shake is detected, an appropriate pair of electrodes which corresponds to the detected camera shake is selected and a voltage supplied to the pair of electrodes is released. The dielectric elastomer which expands before the release of a voltage contracts by this release. The CCD is driven by the contraction of the polymer actuator and the camera shake is compensated.

The description of the embodiments of the present invention is completed above.

What is claimed is:

1. A camera shake compensation unit comprising:
(1) a mobile optical device which allows light incident from a subject to run through the mobile optical device and changes the direction of the light by moving on a two-dimensional plane which intersects with the direction along the light;
(2) a camera shake detection section which detects a camera shake;
(3) a polymer actuator having:
(i) a polymer membrane which expands and contracts in response to application of a voltage, and connects the mobile optical device with a holding section, which is disposed away from the mobile optical device, for holding the mobile optical device; and
(ii) a plurality of electrodes for application of a voltage to parts of the polymer membrane which are disposed apart on the polymer membrane in contact with the polymer membrane;
(4) a camera shake compensation section which compensates for displacement of light incident from a subject caused by a camera shake, by supplying a voltage corresponding to a detection result by the camera shake detection section to the plurality of electrodes and thereby moving the mobile optical device on the two-dimensional plane.

2. A camera shake compensation unit comprising:
(1) a mobile optical device which allows light incident from a subject to run through the mobile optical device and changes the direction of the light by tilting toward the direction along the light;
(2) a camera shake detection section which detects a camera shake;
(3) polymer actuators having:
(i) a plurality of polymer membranes each of which expands and contracts in response to application of a voltage, and extends in the direction of light incident from a subject, while one edge of the polymer membrane being kept fixed on the mobile optical device; and
(ii) a plurality of electrodes each of which is disposed on and applies a voltage to each of the polymer membranes;
(4) a camera shake compensation section which compensates for displacement of light incident from a subject caused by a camera shake, by supplying a voltage corresponding to a detection result by the camera shake detection section to the plurality of electrodes and thereby tilting the mobile optical device.

3. A camera shake compensation unit comprising:
(1) a mobile optical device which allows light incident from a subject to run through the mobile optical device and changes the direction of the light by tilting toward the direction along the light;
(2) a camera shake detection section which detects a camera shake;
(3) a polymer actuator having:
(i) a plurality of polymer membranes which expand and contract in response to application of a voltage, and are disposed apart in the direction of light incident from a subject and connect the mobile optical device with a holding section, which is disposed away from the mobile optical device, for holding the mobile optical device; and
(ii) a plurality of electrodes for application of a voltage to parts of the polymer membranes which are disposed apart on the polymer membranes in contact with the polymer membranes;
(4) a camera shake compensation section which compensates for displacement of light incident from a subject caused by a camera shake, by supplying a voltage corresponding to a detection result by the camera shake detection section to the plurality of electrodes and thereby tilting the mobile optical device.

4. A camera shake compensation unit according to claim 1, wherein the mobile optical device is a lens.

5. A camera shake compensation unit according to claim 2, wherein the mobile optical device is a lens.

6. A camera shake compensation unit according to claim 3, wherein the mobile optical device is a lens.

7. A camera shake compensation unit according to claim 1, further comprising:
an optical membrane which is a membrane made of a transparent material that light runs through, the optical membrane configured as:
(1) being attached on a surface of the mobile optical device through which light incident from a subject runs; and
(2) having at least a part thereof which is not attached on the mobile optical device and is integrated with the polymer membrane.

8. A camera shake compensation unit according to claim 3, further comprising:
an optical membrane which is a membrane made of a transparent material that light runs through, the optical membrane configured as:
(1) being attached on a surface of the mobile optical device through which light incident from a subject runs; and
(2) having at least a part thereof which is not attached on the mobile optical device and is integrated with the polymer membrane.

9. A camera shake compensation unit according to claim 1, wherein the mobile optical device is an optical wedge.

10. A camera shake compensation unit according to claim 3, wherein the mobile optical device is an optical wedge.

11. A camera shake compensation unit comprising:
(1) an image taking device which receives light incident from a subject and generates image signals, and changes a position of receiving the light by moving on a two-dimensional plane which intersects with the direction along the light;
(2) a camera shake detection section which detects a camera shake;
(3) a polymer actuator having:
(i) a polymer membrane which expands and contracts in response to application of a voltage, and connects the image taking device with a holding section, which is disposed away from the image taking device, for holding the image taking device; and
(ii) a plurality of electrodes for application of a voltage to parts of the polymer membrane which are disposed apart on the polymer membrane in contact with the polymer membrane;
(4) a camera shake compensation section which compensates for displacement of light incident from a subject caused by a camera shake, by supplying a voltage corresponding to a detection result by the camera shake detection section to the plurality of electrodes and thereby moving the image taking device on the two-dimensional plane.

12. A camera shake compensation unit according to claim 1, wherein the camera shake compensation section applies a voltage of a value corresponding to the detected result of the camera shake detection section.

13. A camera shake compensation unit according to claim 11, wherein the camera shake compensation section applies a voltage of a value corresponding to the detected result of the camera shake detection section.

14. A camera shake compensation unit according to claim 1, wherein the camera shake compensation section supplies pulse voltages of a pulse width corresponding to the detected result of the camera shake detection section.

15. A camera shake compensation unit according to claim 11, wherein the camera shake compensation section supplies pulse voltages of a pulse width corresponding to the detected result of the camera shake detection section.

16. A camera shake compensation unit according to claim 1, wherein the polymer membrane expands and contracts as much as an amount corresponding to an average of an applied voltage in the case that the applied voltage is varied with passage of time.

17. A camera shake compensation unit according to claim 11, wherein the polymer membrane expands and contracts as much as an amount corresponding to an average of an applied voltage in the case that the applied voltage is varied with passage of time.

18. A camera shake compensation unit according to claim 1, wherein the polymer membrane expands and contracts in response to release of an applied voltage, and the camera shake compensation section releases a voltage supplied to the electrodes for a compensation for a camera shake, instead of supplying a voltage.

19. A camera shake compensation unit according to claim 11, wherein the polymer membrane expands and contracts in response to release of an applied voltage, and the camera shake compensation section releases a voltage supplied to the electrodes for a compensation for a camera shake, instead of supplying a voltage.

20. An image taking apparatus which shoots a subject comprising:
(1) a mobile optical device which allows light incident from a subject to run through the mobile optical device and changes the direction of the light by moving on a two-dimensional plane which intersects with the direction along the light;
(2) a camera shake detection section which detects a camera shake;
(3) a polymer actuator having:
(i) a polymer membrane which expands and contracts in response to application of a voltage, and connects the mobile optical device with a holding section, which is disposed away from the mobile optical device, for holding the mobile optical device; and
(ii) a plurality of electrodes for application of a voltage to parts of the polymer membrane which are disposed apart on the polymer membrane in contact with the polymer membrane;
(4) a camera shake compensation section which compensates for displacement of light incident from a subject caused by a camera shake, by supplying a voltage corresponding to a detection result by the camera shake detection section to the plurality of electrodes and thereby moving the mobile optical device on the two-dimensional plane.

21. An image taking apparatus which shoots a subject comprising:
(1) a mobile optical device which allows light incident from a subject to run through the mobile optical device and changes the direction of the light running through the mobile optical device by tilting toward the direction along the light;
(2) a camera shake detection section which detects a camera shake;
(3) polymer actuators having:
(i) a plurality of polymer membranes each of which expands and contracts in response to application of a voltage, and extends in the direction of light incident from a subject, while one edge of the polymer membrane kept fixed on the mobile optical device; and
(ii) a plurality of electrodes each of which is disposed on each of the plurality of polymer membranes for application of a voltage to each of the plurality of polymer membranes;
(4) a camera shake compensation section which compensates for displacement of light incident from a subject caused by a camera shake, by supplying a voltage corresponding to a detection result by the camera shake detection section to the plurality of electrodes and thereby tilting the mobile optical device.

22. An image taking apparatus which shoots a subject comprising:
(1) a mobile optical device which allows light incident from a subject to run through the mobile optical device and changes the direction of the light running through the mobile optical device by tilting toward the direction along the light;
(2) a camera shake detection section which detects a camera shake;
(3) a polymer actuator having:
(i) a plurality of polymer membranes which expand and contract in response to application of a voltage, and are disposed apart in the direction of light incident from a subject and connect the mobile optical device with a holding section, which is disposed away from the mobile optical device, for holding the mobile optical device; and
(ii) a plurality of electrodes for application of a voltage to parts of the polymer membranes which are disposed apart on the polymer membranes in contact with the polymer membranes;
(4) a camera shake compensation section which compensates for displacement of light incident from a subject caused by a camera shake, by supplying a voltage corresponding to a detection result by the camera shake detection section to the plurality of electrodes and thereby tilting the mobile optical device.

23. An image taking apparatus which shoots a subject comprising:
(1) an image taking device which receives light incident from a subject and generates image signals, and changes a position of receiving the light by moving on a two-dimensional plane which intersects with the direction along the light;
(2) a camera shake detection section which detects a camera shake;
(3) a polymer actuator having:
(i) a polymer membrane which expands and contracts in response to application of a voltage, and connects the image taking device with a holding section, which is disposed away from the image taking device, for holding the image taking device; and
(ii) a plurality of electrodes for application of a voltage to parts of the polymer membrane which are disposed apart on the polymer membrane in contact with the polymer membrane;
(4) a camera shake compensation section which compensates for displacement of light incident from a subject caused by a camera shake, by supplying a voltage corresponding to a detection result by the camera shake detection section to the plurality of electrodes and thereby moving the image taking device on the two-dimensional plane.

24. An image taking system having:
(1) an image taking apparatus which forms an image based on light incident from a subject and generates image signals which represent a subject image; and
(2) an image formation position compensation unit which is removably mounted on the image taking apparatus and controls the image taking apparatus to compensate for displacement of an image formation position of the light, the image taking system comprising:
(A) an image taking apparatus including:
(1) a mobile optical device which allows light incident from a subject to run through the mobile optical device and changes the direction of the light by moving on a two-dimensional plane which intersects with the direction along the light;
(2) a polymer actuator having:
(i) a polymer membrane which expands and contracts in response to application of a voltage, and connects the mobile optical device with a holding section, which is disposed away from the mobile optical device, for holding the mobile optical device; and
(ii) a plurality of electrodes for application of a voltage to parts of the polymer membrane which are disposed apart on the polymer membrane in contact with the polymer membrane;
(3) a connection section on which the image formation position compensation unit is mounted removably, and
(B) an image formation position compensation unit including a displacement compensation section which recognizes an amount of displacement of an image formation position of light incident from a subject and compensates for the displacement of the image formation position of the light by supplying a voltage corresponding to the amount of the displacement to the plurality of electrodes and thereby moving the mobile optical device on the two-dimensional plane.

25. An image taking system according to claim 24, wherein the mobile optical device is a lens.

26. An image taking system according to claim 24, further comprising:
an optical membrane made of a transparent material that light runs through, the optical membrane configured as:
(1) being attached on a surface of the mobile optical device through which light incident from a subject runs; and
(2) having at least a part thereof which is not attached on the mobile optical device and is integrated with the polymer membrane.

27. An image taking system according to claim 25, further comprising:
an optical membrane made of a transparent material that light runs through, the optical membrane configured as:
(1) being attached on a surface of the mobile optical device through which light incident from a subject runs; and
(2) having at least a part thereof which is not attached on the mobile optical device and is integrated with the polymer membrane.

28. An image taking system according to claim 24,
wherein the image taking apparatus includes an image signal generation section which generates image signals by receiving light incident from a subject which runs through the mobile optical device,
the image taking system further includes a displacement calculation section which calculates an amount of displacement of an image formation position of light incident from a subject based on the image signal, and
the displacement compensation section recognizes the amount of displacement of an image formation position by obtaining the amount of displacement of the image formation position calculated by the displacement calculation section.

29. An image taking system according to claim 24, wherein the displacement compensation section applies a voltage of a value corresponding to the amount of displacement of the image formation position.

30. An image taking system according to claim 24, wherein the displacement compensation section supplies pulse voltages of a pulse width corresponding to the amount of displacement of the image formation position.

31. An image taking system according to claim 24, wherein the image taking apparatus includes a position fixing section which fixes the mobile optical device on a position where displacement of the image formation position is compensated for.

32. An image taking system according to claim 24, wherein the polymer membrane expands and contracts as much as an amount corresponding to an average of an applied voltage in the case that the applied voltage is varied with passage of time.

33. An image taking system according to claim 30, wherein the polymer membrane expands and contracts as much as an amount corresponding to an average of an applied voltage in the case that the applied voltage is varied with passage of time.

34. An image taking system according to claim 24, wherein the polymer membrane expands and contracts in response to release of an applied voltage, and the displacement compensation section releases a voltage supplied to the electrodes for a compensation for displacement of the image formation position.

35. A compensation method of an image formation position of light incident from a subject in an image taking apparatus which forms an image based on light incident from a subject and generates image signals which represent a subject image, the compensation method of image formation position comprising:
(1) recognizing an amount of displacement of an image formation position of light incident from a subject;
(2) compensating for the displacement of the image formation position of the light using a polymer actuator, the polymer actuator having:
(i) a polymer membrane which expands and contracts in response to application of a voltage, and connects the mobile optical device with a holding section, which is disposed away from the mobile optical device, for holding the mobile optical device; and
(ii) a plurality of electrodes for application of a voltage to parts of the polymer membrane which are disposed apart on the polymer membrane in contact with the polymer membrane;
by supplying a voltage corresponding to the amount of the displacement recognized in the recognizing an amount of displacement of an image to the plurality of electrodes and thereby moving the mobile optical device on the two-dimensional plane; and
(3) fixing the mobile optical device on the position where displacement of the image formation position is compensated for.

36. A camera shake compensation unit comprising:
(1) an image taking device which receives light incident from a subject and generates image signals, and changes a position of receiving the light by rotating on a two-dimensional plane which intersects with the direction along the light;
(2) a camera shake detection section which detects a camera shake;
(3) a polymer actuator having:
(i) a polymer membrane which expands and contracts in response to application of a voltage, and connects the image taking device with a holding section, which is disposed away from the image taking device, for holding the image taking device; and
(ii) a plurality of electrodes for application of a voltage to parts of the polymer membrane which are disposed apart on the polymer membrane in contact with the polymer membrane;
(4) a camera shake compensation section which compensates for displacement of the light incident from a subject caused by a camera shake, by supplying a voltage corresponding to a detection result by the camera shake detection section to the electrodes and thereby rotating the image taking device on the two-dimensional plane.

37. A camera shake compensation unit according to claim 36, wherein the camera shake compensation section compensates for displacement of light incident from a subject caused by a camera shake, by supplying a voltage corresponding to a detection result by the camera shake detection section to the plurality of electrodes and thereby shifting and rotating the image taking device on the two-dimensional plane.

38. A camera shake compensation unit according to claim 36, wherein the camera shake compensation section applies a voltage of a value corresponding to the detected result of the camera shake detection section.

39. A camera shake compensation unit according to claim 36, wherein the camera shake compensation section supplies pulse voltages of a pulse width corresponding to the detected result of the camera shake detection section.

40. A camera shake compensation unit according to claim 36, wherein the polymer membrane expands and contracts as much as an amount corresponding to an average of an applied voltage in the case that the applied voltage is varied with passage of time.

41. A camera shake compensation unit according to claim 36, wherein the polymer membrane expands and contracts in response to release of an applied voltage, and the camera shake compensation section releases a voltage supplied to the electrodes for a compensation for a camera shake, instead of supplying a voltage.

42. An image taking apparatus which shoots a subject comprising:
(1) an image taking device which receives light incident from a subject and generates image signals, and changes a position of receiving the light by rotating on a two-dimensional plane which intersects with the direction along the light;
(2) a camera shake detection section which detects a camera shake;
(3) a polymer actuator having:
(i) a polymer membrane which expands and contracts in response to application of a voltage, and connects the image taking device with a holding section, which is disposed away from the image taking device, for holding the image taking device; and
(ii) a plurality of electrodes for application of a voltage to parts of the polymer membrane which are disposed apart on the polymer membrane in contact with the polymer membrane;
(4) a camera shake compensation section which compensates for displacement of light incident from a subject caused by a camera shake, by supplying a voltage corresponding to a detection result by the camera shake detection section to the plurality of electrodes and thereby rotating the image taking device on the two-dimensional plane.
